(19) United States
(12) Patent Application Publication
(10) Pub. No.: US 2004/0039629 A1
(43) Pub. Date: Feb. 26, 2004

(54) Web based method and system for managing and transferring business information

(76) Inventors: Kevin Hoffman, Gaithersburg, MD (US); Jim Anzalone, Ashburn, VA (US); Chris Cormack, Ashburn, VA (US)

Correspondence Address: FLESHNER & KIM, LLP, P.O. Box 221200, Chantilly, VA, 20153-1200, US

(21) Appl. No.: 10/336,036

(22) Filed: Jan. 3, 2003

Related U.S. Application Data
(63) Continuation-in-part of application No. 10/310,979, filed on Dec. 6, 2002.
(63) Continuation-in-part of application No. 10/310,976, filed on Dec. 6, 2002.
(63) Continuation-in-part of application No. 10/310,982, filed on Dec. 6, 2002.
(63) Continuation-in-part of application No. 10/310,981, filed on Dec. 6, 2002.
(60) Provisional application No. 60/382,387, filed on May 23, 2002.

(51) Int. Cl. G06F 17/60

(52) U.S. Cl. 705/10; 705/1

(57) ABSTRACT

In the general business environment, in order to keep track of the activities involved in selling, buying, or leasing a product, a business information managing and transferring system and method have been developed. In an embodiment of a business transaction system of the invention, several modules have been communicatively coupled to provide a complete and reliable system of tracking buyers' and sellers' activities and keeping an Agent informed and prepared at all times. The business managing and transferring system can be made accessible by users, such as agents, and can include a host server with communicatively adapted parts to manage and transfer business information.

This application is a continuation-in-part of prior application Ser. No. 10/310,979, filed Dec. 6, 2002; application Ser. No. 10/310,976, filed Dec. 6, 2002; application Ser. No. 10/310,982; and application Ser. No. 10/310,981, filed Dec. 6, 2002. This application also claims priority to Provisional Application No. 60/382,387, filed May 23, 2002.

### BACKGROUND OF THE INVENTION

1. Field of the Invention

This invention relates generally to a web based business transaction system that allows users to create, access, and modify information regarding business transactions.

2. Background of the Related Art

People spend a considerable amount of time every day keeping track of important information such as due dates and appointments. Methods of keeping track of one's day-to-day operations are constantly improving in order to streamline and improve both the functionality and efficiency of methods for managing and transferring information.

Among the most deadline sensitive business sectors is the business transaction sector. Agents hired by parties to a business transaction, spend considerable amounts of time keeping track of business transaction information, such as due dates, product data and client data. If an agent fails to properly track a business transaction, it may cause problems, including causing the Agent to lose a sale. As such, it is important for Agents to constantly maintain updated calendars in order to track all transactions so as to avoid missing any due dates. However, due to the complexity of the business transactions, proper tracking and maintenance of business transaction information has been difficult.

Generally, business transactions are approached from two different vantage points. The first is offering a product for sale to the general public on behalf of a person owning the product, and the second is seeking a product on behalf of a person desiring to acquire it. The product can be commercial, residential, industrial, or any other type of product, and the person can be a single person, multiple people, a business, a corporation, or other entity. The first vantage point focuses on the sale of a subject product, while the second vantage point focuses on the purchase of a subject product.

From the first vantage point, the seller, who can be the owner, lien-holder or other interested party of a subject product, often hires a listing Agent who markets and advertises the subject product to prospective buyers. Prospective buyers can include a single person, multiple people, businesses, corporations, their agents or other parties seeking a business product. The listing Agent often provides in their marketing and advertising materials information, such as functional characteristics of the product, which can include a product's offering price, size and location, as well as other pertinent information for prospective buyers.

The listing Agent may also provide the seller with information regarding prospective buyers who have exhibited interest in the product, such as their opinions or comments, as well as any contractual offers. The listing Agent may also provide the seller with information during the marketing and advertising process regarding actions performed by the listing Agent on behalf of the seller. In order to keep the seller well informed, the listing Agent must constantly be in contact with the seller. This high level of contact must be maintained until the final closing on the subject product. This constant contact can often be inconvenient and disruptive, and can be difficult to maintain for both the Agent and the seller. Therefore, a better method of managing and transferring business transaction information is desired.

From the second vantage point, a buyer often hires a buyer's agent or Agent to find, negotiate, and assist in purchasing a product for the buyer. After a contract has been successfully negotiated and accepted by both the seller and the buyer (a ratified contract), the buyer relies on the buyer's agent to keep the buyer informed of all requirements of the contract, including completed or upcoming due dates, in order to successfully transfer title of the product from the seller to the buyer. As such, both the listing Agent and the buyer's agent must monitor all contractual tasks from the ratification date through the settlement date on behalf of the seller and the buyer. Additionally, the listing Agent and the buyer's agent must also monitor all of the contractual tasks from the ratification date to the settlement date on behalf of the seller and the buyer, respectively. This process is inefficient, costly, and time-consuming. Further, it leaves open the possibility that the Agent will overlook a client's specific needs, or provide and/or receive incomplete information regarding the product.

Due to the important nature of these communications and deadlines, as well as the time sensitivity of the various tasks that need to be accomplished, a reliable, dynamically modifiable system for information management and transfer is desired.

### SUMMARY OF THE INVENTION

An object of the invention is to solve at least the above problems and/or disadvantages and to provide at least the advantages described hereinafter.

In order to achieve at least the above objects in whole or in parts, and in accordance with the purpose of the invention, as embodied and broadly described, there is provided a network-based business information managing and transferring system accessible by end users, including a host server with a folder module adapted to contain information about a business product or transaction, a reports module communicatively coupled to the folder module, wherein the reports module is adapted to search and filter information from the folder module, and an activity map module communicatively coupled to at least one of the folder module and the reports module, wherein the activity map module comprises a database of stored features and is adapted to extract information from at least one of the folder module and the reports module and manipulate the extracted information using the stored features to provide docketing information and calendaring functions to the end users, wherein the stored features comprise at least one of a calculator to calculate due dates, a hyperlink to allow connecting between the folder module, the reports module and the activity map module, an automatic file saver, a new activity entry generator, a letter campaign generator, an instruction adding generator, a note generator, and a display interface.

To further achieve at least the above objects in whole or in parts, and in accordance with the purpose of the present invention, as embodied and broadly described, there is provided a computer-implemented method of generating information for business management, including entering information regarding a business transaction into a folder module, compiling and filtering the information regarding the business transaction into a reports module communicatively coupled to the folder module, and automatically generating a calendar of activities and due dates from the information in the folder module, the reports module, and the showings module.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, wherein:

FIG. 1 is a schematic diagram showing a network based system for transferring and managing business information;

FIG. 1A is a schematic diagram of a database structure of a system access module in accordance with an embodiment of the invention.

FIG. 1B is a schematic diagram of a table structure of a database structure in accordance with an embodiment of the invention.

FIG. 1C is a schematic diagram of a table structure of a database structure in accordance with an embodiment of the invention.

FIG. 1D is a schematic diagram of a table structure of a database structure in accordance with an embodiment of the invention.

FIG. 2 is a schematic diagram of a system access module in accordance with an embodiment of the invention;

FIG. 3 is a schematic diagram of a folder module in accordance with an embodiment of the invention;

FIG. 3A is a flow chart diagram of an information update module in accordance with an embodiment of the invention;

FIG. 4 is a schematic diagram of an activity map module in accordance with an embodiment of the invention;

FIG. 5 is a schematic diagram of a showings module in accordance with an embodiment of the invention;

FIG. 6 is a schematic diagram of a reports module in accordance with an embodiment of the invention;

FIG. 7 is a schematic diagram of a contact management module in accordance with an embodiment of the invention;

FIG. 8 is a schematic diagram of a reservation module in accordance with an embodiment of the invention;

FIG. 9 is a schematic diagram of a website management access module in accordance with an embodiment of the invention;

FIG. 10 is a schematic diagram of a transaction fee coordinating module in accordance with an embodiment of the invention;

FIG. 11 is a schematic diagram of a web based network for transferring and managing information in accordance with an embodiment of the invention;

FIG. 12 is a screen shot of an Agent's view of a web based application for transferring and managing information;

FIG. 13 is a screen shot detailing an Agent's view of a reports menu of a web based application;

FIG. 14 is a screen shot detailing an Agent's view of a transaction manager report of a web based application;

FIG. 14A is a screen shot detailing an Agent's view of a scroll down menu of a transaction manager report of a web based application;

FIG. 14B is a screen shot detailing an Agent's view of a second scroll down menu of a transaction manager report of a web based application;

FIG. 15 is a screen shot detailing an Agent's view of the all due activities of a web based application;

FIG. 16 is a screen shot detailing an Agent's view of the open activities of a web based application;

FIG. 17 is a screen shot detailing an Agent's view of an all showings by an agent menu of a web based application;

FIG. 18 is a screen shot detailing an Agent's view of a settlement summary of a web based application;

FIG. 19 is a screen shot detailing an Agent's view of a my folder archive of a web based application;

FIG. 20 is a screen shot detailing an Agent's view of client login information of a web based application;

FIG. 21 is a screen shot detailing an Agent's view of folders by e-mail address of a web based application;

FIG. 22 is a screen shot detailing an Agent's view of my folders option of a web based application;

FIG. 23 is a screen shot detailing an Agent's view of website hits of a web based application;

FIG. 24 is a screen shot detailing an Agent's view of an other reports menu of a web based application;

FIG. 25 is a screen shot detailing an Agent's view of a service provider option of a web based application;

FIG. 26 is a screen shot detailing an Agent's view of a my client feedback option of a web based application;

FIG. 26A is a screen shot detailing an Agent's view of a read feedback option of a my client feedback option of a web based application;

FIG. 27 is a screen shot detailing an Agent's view of a truck reservation information option of a web based application;

FIG. 28 is a screen shot detailing an Agent's view of a contact manager drop down menu of a web based application;

FIG. 29 is a screen shot detailing an Agent's view of a my contacts option of a web based application;

FIG. 30 is a screen shot detailing an Agent's view of an add new contacts option of a web based application;

FIG. 31 is a screen shot detailing an Agent's view of a mail merge option of a web based application;

FIG. 32 is a screen shot detailing an Agent's view of a broadcast alert message option of a web based application;

FIG. 33 is a screen shot detailing an Agent's view of a previous email message option of a web based application;

FIG. 34 is a screen shot detailing an Agent's view of a letter campaign generator option of a web based application;

FIG. 35 is a screen shot detailing an Agent's view of a letter calendar of a web based application;

FIG. 36 is a screen shot detailing an Agent's view of an import/export option of a web based application;

FIG. 37 is a screen shot detailing an Agent's view of a tools and settings drop down option menu of a web based application;

FIG. 38 is a screen shot detailing an Agent's view of an edit master maps option menu of a web based application;

FIG. 39 is a screen shot detailing an Agent's view of a user control panel menu option of a web based application;

FIG. 40 is a screen shot detailing an Agent's view of a settings option menu of a web based application;

FIG. 41 is a screen shot detailing an Agent's view of an edit web pages option menu of a web based application;

FIG. 42 is a screen shot detailing an Agent's view of a read FACS option of a web based application;

FIG. 43 is a screen shot detailing an Agent's view of an instant messaging help service option of a web based application;

FIG. 44 is a screen shot detailing an Agent's view of a report an issue option of a web based application;

FIG. 45 is a screen shot detailing an Agent's view of a pin calendar option of a web based application;

FIG. 46 is a screen shot detailing a client view of a web based application;

FIG. 47 is a screen shot detailing a showings option in a client view of a web based application;

FIG. 48 is a screen shot detailing a what's next option in a client view of a web based application.

FIG. 49 is a screen shot detailing a service provider link in a client view of a web based application;

FIG. 50 is a screen shot detailing a feedback option in a client view of a web based application;

FIG. 51 is a screen shot detailing a client information email in a client view of a web based application; and

FIG. 52 is a screen shot detailing a reserve truck option in a client view of a web based application.

### DETAILED DESCRIPTION OF PREFERRED EMBODIMENTS

In the business transactions, in order to keep track of the activities involved in selling, buying, or leasing a product, a business information managing and transferring system and method have been developed. According to a preferred embodiment of a business transaction system of the invention, several communicatively coupled modules are provided to provide a complete and reliable system of tracking buyers' and sellers' activities, as well as keeping an Agent informed and prepared at all times. The business managing and transferring system can be made accessible by local and remote users, and can include a host server with communicatively adapted parts to manage and transfer business information.

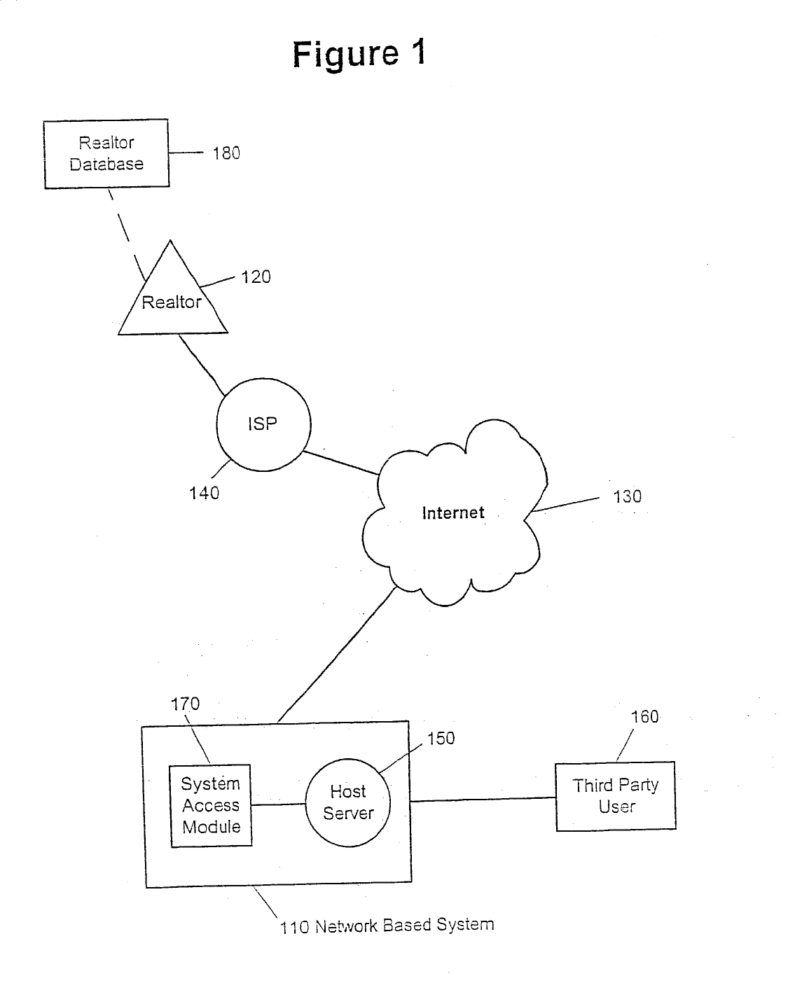

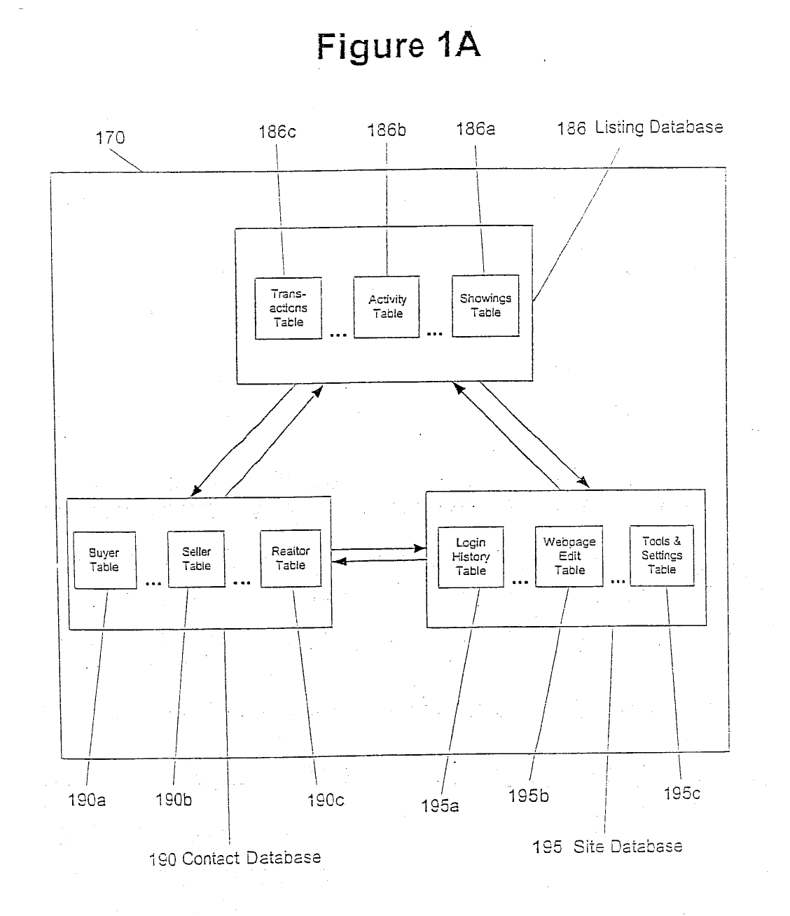

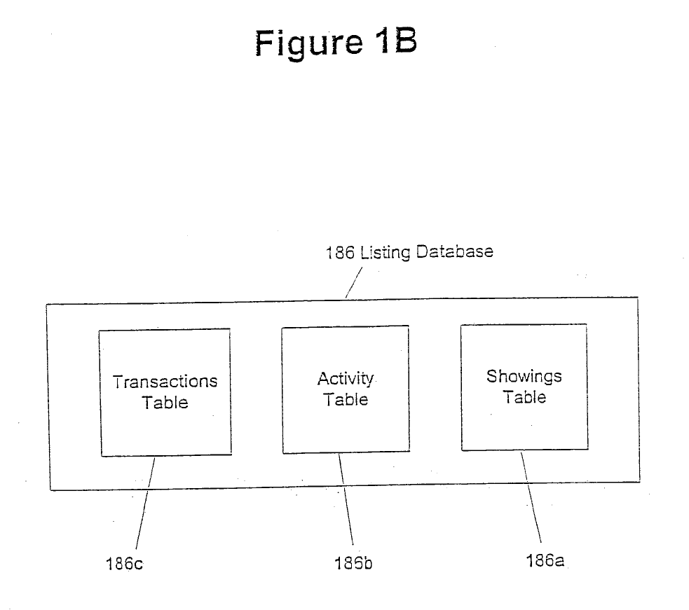

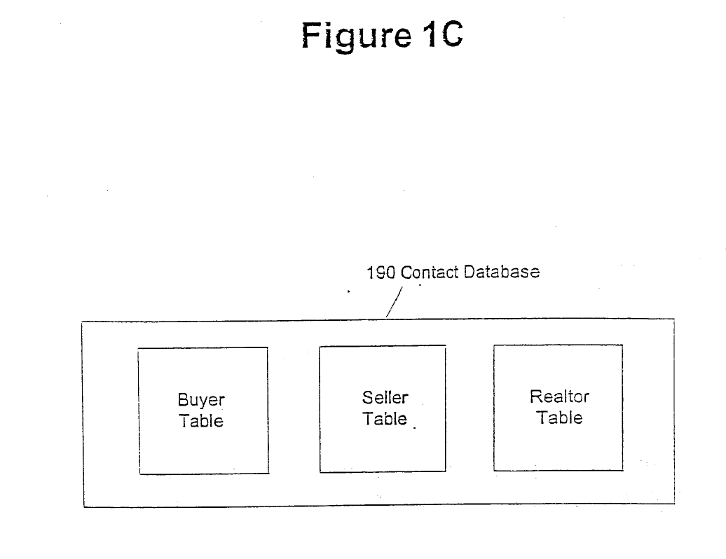

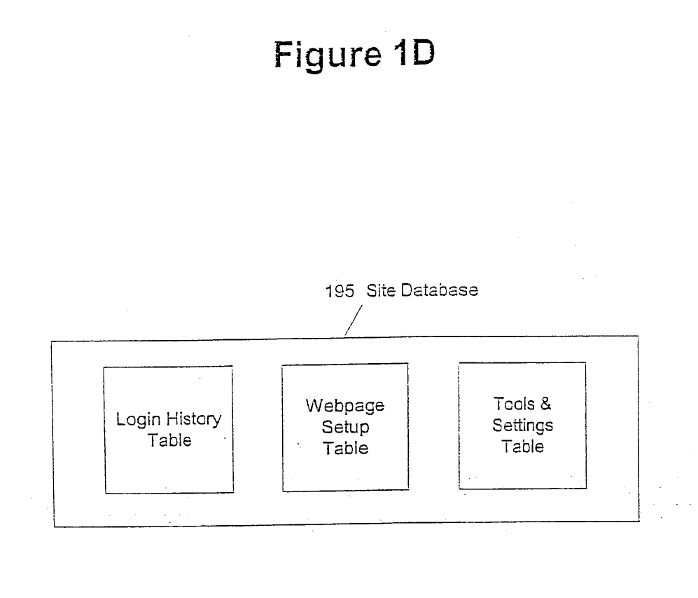

FIG. 1 illustrates a system structure of a network based system. As illustrated in FIG. 1, a network-based system 110, is preferably a web-based system, but could be any other equivalent or similar system. The network-based system 110 linking buyers, sellers, and/or Agents according to prescribed criteria is shown in FIG. 1. Referring to FIG. 1, an Agent 120 establishes a communication to the Internet 130 through an Internet Service Provider (ISP) 140. The network based system 110 is also preferably coupled to the Internet 130. The Agent 120 can thus establish communication with the network based system 110 over the Internet 130.

The network based system 110 preferably includes a host server 150 which contains instructions for sorting through information provided by the Agent 120, as well as information provided by a third party user 160, such as a buyer or seller. The information provided by either the Agents 120 or third parties 160 is preferably stored in a System Access Module 170 and displayed on a website. In the preferred embodiment, the System Access Module 170 is at least made up of up of at least three databases, which will be described in further detail below. Additionally, an Agent can provide their own database information 180, and allow the network based system 110 to access that database 180 through the Internet 130. Similarly, the Agent, could link directly to the server 150 to provide the network-based system 110 with access to buyers or sellers or other parties.

FIG. 1A shows additional detail of a database structure of the System Access Module 170. As shown in FIG. 1A, the System Access Module 170 preferably includes separate databases that are communicatively coupled to one another and more preferably includes three separate databases. The three databases can include a listing database 186, a contact database 190, and a site database 195. Each database preferably includes a set of tables, which allows information to be entered, sorted, stored, compiled, retrieved, and transferred to other ones of the databases according to prescribed criteria. Although three tables are shown in each of the databases, it should be understood that any number of tables could be included. The set of tables may be developed using any standard platform such as Oracle, Cold Fusion, or preferably Lotus Domino. The software code may be written in any standard programming language, such as JavaScript, HTML, C++, or preferably Lotus Script. Once the databases are created they may be communicatively coupled and viewed seamlessly through an interface. The interface may be uploaded to a website and accessed through the Internet. Accordingly, a user who accesses the databases could do so without knowledge that retrieved information was being provided from the separate databases.

Additional information regarding the listing database 186 is next provided. As shown in FIG. 1B, the listing database preferably includes a set of individual tables within the database. The tables may be used to store data information which may be entered manually or automatically. Although the preferred method of storing information is the use of tables, it should be understood that any mechanism of storing fields of information may be used. Each piece of data used to populate the tables is automatically assigned a unique identifier (ID). For example, in the listing database 186, there may be a plurality of tables, such as a showings table 186a, an activity map table 186b, and a transaction manager reports table 186c. Each piece of data used by the system is thus organized in an appropriate table in accordance with its unique ID. Preferably, the unique ID is used to retrieve information from the other databases 190, 195. Table information may include transaction information about a house, land, apartment, or any real product for sale, showings information, letter generator information, selling Agent/buyer feedback/comments information, activities information, and transaction information. The table information may be searched by using a character search or a unique ID search.

Additional detail regarding the contact database 190 is next provided. As shown in FIG. 1C, the contact database 190 preferably includes a plurality of tables. For example, the contact database 190 may include a buyer's table 190a, a seller's table 190b, and an Agent table 190c. Each piece of data used to populate the tables is automatically assigned a unique ID. The data is organized in an appropriate table in accordance with the unique ID. Table information may include separate tables for contact information for Agents, buyers, sellers, service providers, or any party involved in a business transaction. The contact database 190 includes a contact management module, a contact information memory module, a letter generator module, and a contact information automatic updating module. The contact database may also include an equipment reservation module and a rental rules module. The table information may be searched by using a character search or a unique ID search.

Additional information regarding the site database 195 is next provided. As shown in FIG. 1D, the site database 195 preferably includes a plurality of tables. For example, it may include a login history table 195a, a web page edit table 195b, and a tools and settings table 195c. Each piece of data used to populate the tables is automatically assigned a unique ID. The data is organized in an appropriate table in accordance with the unique ID. Table information may include separate tables for information such as user logon information, website management information, a referrals information, a payment information, and/or any other website management information. The table information may be searched by using a character search or a unique ID search.

Each of the three databases 186, 190, 195 preferably interacts with the other's to manage data and generate various reports. For example, the contact database 190 could work in conjunction with the listing database 186 to generate a letter to a potential buyer after a listed product is shown. Additionally, invoices generated by the listings database 186 could be coupled with letters generated by the contact database 190. It should be understood that any number of fields could be included in each of the databases, and the above descriptions are given by way of example only. Additionally, it should be understood that certain data items are generated by the various databases, and do not need to be entered manually by a user.

Additional information regarding the interconnectivity between the three databases 486, 190, 195 is next provided. As mentioned above, the information entered into the tables of each database is preferably given a unique identifier (ID). This ID is preferably used to identify and authenticate information. The information in each database is made available to the other databases by using a database linking mechanism, which may be provided by any database platform. It should be noted however, that any linking mechanism may be used.

Preferably, all three databases are interconnected by a database link, which is used to search, retrieve, update, and transfer information. In a preferred embodiment of the present invention, at least one of the three databases has to be designated a home database. Preferably, the home database is determined by what database contains the most information regarding a specific query. However, any method of determining a home database may be used.

Additional information regarding the home database is next provided. The home database receives a user query and translates the user query into a series of unique IDs. The unique IDs are then transmitted from the home database to the other databases using the database link. Each database gathers the pertinent information based on the unique ID. The result of the gathered information from all three databases is then displayed as a cohesive unit, as a response to the user query. It should be noted that any database may designated the home database.

It should be understood that any number of databases could be used to achieve the same functionality. For example, all of the information could be included in a single database and separated into a plurality of tables. Alternatively, more than three databases could be used.

Additional information regarding a user query is next provided. The user may access the web page and enter query information. For example, the web page may store a plurality of information links for a user to choose from. Each information link is considered a query. For example, one such link is a showings information link. This query can include information residing on all three databases. The showings information link thus may include information such as an image of a house, an Agent's contact information, and price information. Also included may be information regarding what buyers have previously viewed the house and what comments were made regarding the house. Once the link is selected, the home database, which is the listing database 186 in this example, receives, organizes, and translates the query into the series of unique IDs. The listing database 186 then pulls from its tables any information involved with that query. The listing database 186 then retrieves an Agent contact information through the database link from the contact database 190. The listing database 186 then retrieves a user history log-on and feedback information through a database link from the site database 195. The linking database 186 then compiles the information and preferably displays it by loading it onto the Internet web sites The user can then view the information seamlessly through the web site interface.

Also, the preferred embodiment implements a single sign-on mechanism that coordinates log-ons to all three databases in a computer network with preferably one ID and password. Also included may be a master key used to synchronize a set of information entries made on the databases. The synchronization allows for real time update capabilities. For example, if a user provides updated information via the web site interface, the tables in the listing, contact, and site databases 186, 190, 195 automatically receive and update corresponding information. Thus, a user receives all the necessary information from the individual databases without delay. Any application used in creating the databases may include the single sign on mechanism. For example, Microsoft NT, Oracle, SQL, Lotus Notes, or PeopleSoft. Once a user enters the user name and password information the user query may be entered to retrieve pertinent information from the three databases.

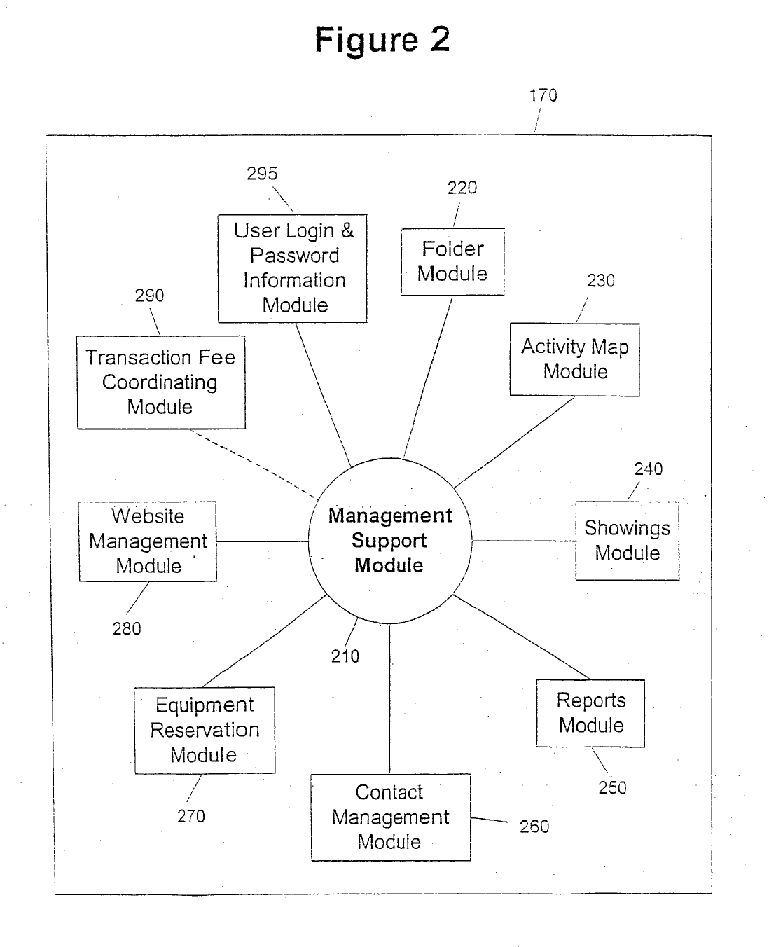

FIG. 2 shows additional detail of the System Access Module 170. As shown in FIG. 2, the System Access Module 170 preferably includes a management support module 210 that provides access to information typically used to manage business transactions. For example, the System Access Module 170 preferably includes a series of modules linked by the management support module 210. These modules include a folder module 220, an activity map module 230, a showings module 240, a reports module 250, a contact management module 260, an equipment reservation module 270, a website management module 280, a transaction fee coordinating module 290, and a user login and password information module 295. Other modules may also be provided based on the particular needs of the Agent.

Each module may be communicatively coupled to the management support module 210 to allow a user of the system to create or modify any information regarding business transactions and other pertinent information. These modules can be used as standalone modules, or can be integrated to form a cohesive network based management tool.

The user login and password information module 295 may be used to restrict or limit access to the public, while allowing various levels of access to an Agent, buyer, seller or other interested party depending upon the user. This can allow an Agent to control access into the folder module so that only the Agent can edit information therein, while a buyer, seller, or other interested party can only read the information that the Agent permits them to read.

The folder module 220 preferably stores information about selected business properties, as well as an information compiling section referred to herein as a reports module, and a scheduling section referred to herein as an activity map module. The host server can also include other modules, where the term “modules” is intended to include any organized grouping of instructions for a mechanized or computerized device including software for a computer and the programs therein, as well as other types of logic layers or instruction sets that can affect the outcome as instructed. For example, the folder module 220 may be used to store and access names and addresses of a seller and/or buyer, and product descriptive information, such as images and location.

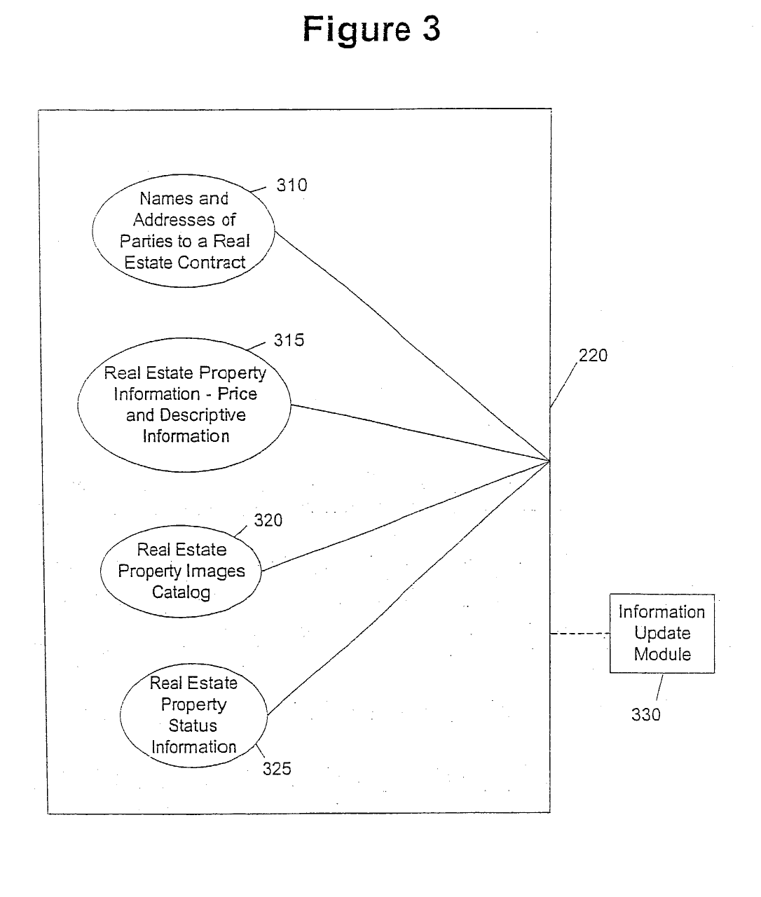

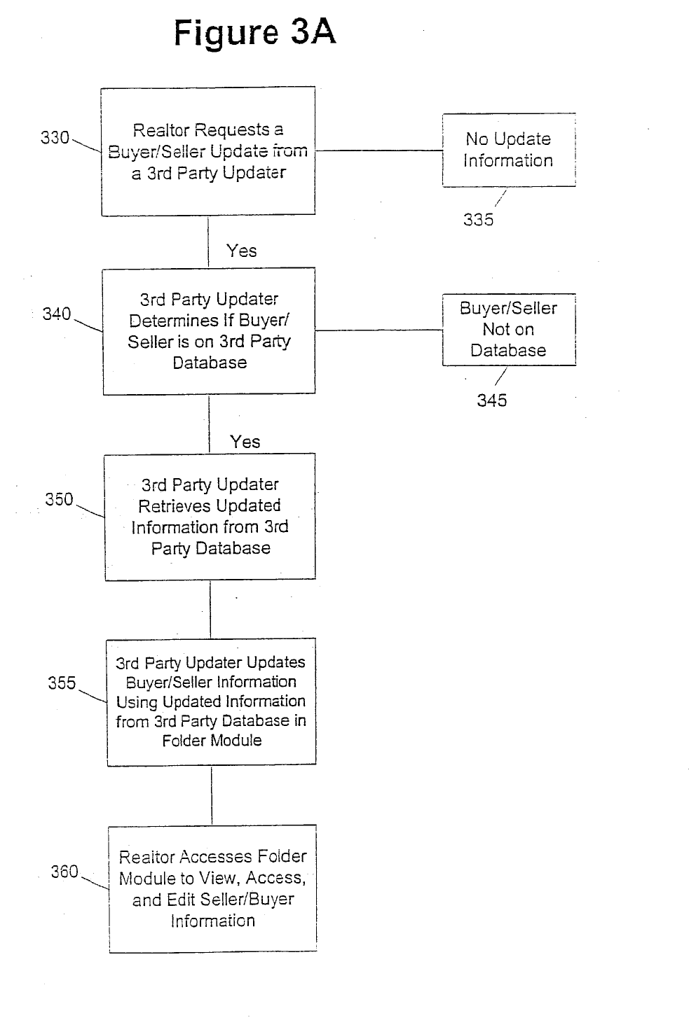

FIG. 3 illustrates additional detail of the folder module. As shown in FIG. 3, the folder module 220 preferably stores information about selected business properties. For example, the folder module 220 may be used to store and access names and addresses of parties to a business contract 310, as well as business product information, such as price and descriptive information 315. Further, the folder module 220 preferably includes a product image catalog 320 that provides images of properties. These images could be either still images or video images, and could be provided in any electronic format. Also, the folder module 220 may include a business status information tool 325 to provide information used to make a purchase decision, and a product selection and price quotation system that preferably captures, analyzes, and makes decisions based on a set of domain-specific variables. Other information may also be provided as desired based on the particular requests or needs of a user. Also, the folder module 220 may be used to store and access information on any other parties, such as inspectors, mortgage agents, landscapers, and entities providing other services.

The business product information 315 in the folder module 220 preferably includes a written description of the product, including pricing and other descriptive information. For example, the written description can include the address of the product, the number of rooms, the types of rooms, the total square footage, and any other relevant information. Additionally, a virtual tour of a subject product and a product's map location could be provided. Additionally, some of this information, such as the offering price and the description may be altered as necessary by authorized users to correct or update information, as well as, to account for market conditions. Also, the folder module may be automatically updated using an information update module 330.

FIG. 3A illustrates an information update module 330. In a preferred embodiment of the present invention, the information update module 330 receives information from third party databases via the Internet and updates the folder module 220. As shown in FIG. 3A, an Agent can request a buyer/seller update information from a third party updater, for example a trade association, such as Service One Association of Agents (SOAR), 330. If no updated information is available, then nothing further occurs 335. However, if there is updated information, the third party updater determines if the buyer/seller is on a third party database, such as a multi-listing services (MLS) 340. If the updated information is not available on the third party database then nothing further occurs, 345. However, if updated information is available, the third party updater retrieves the updated information from the third party database 340. The third party updater proceeds to update the buyer/seller information using updated information received from the third party database 355. The Agent can then access the information via the folder module 220, to view, edit, or print the updated seller/buyer information 360. Preferably, the folder module 220 automatically sorts the information.

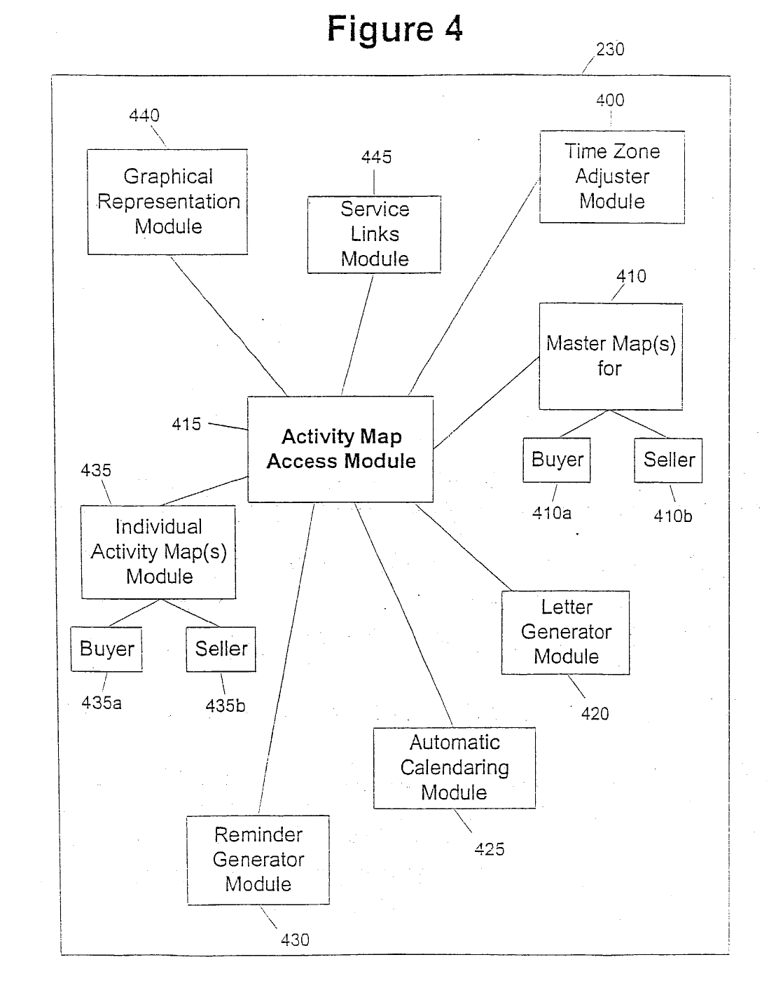

FIG. 4 illustrates additional detail of the activity map module 230. The activity map module 230 preferably compiles the information from the folder module 220 and creates a schedule or “activity map.” The activity map includes such information as critical dates, business transaction related activities, and deadlines for the business transaction related activities. Further, it stores dates, times, and, in certain cases, locations of important events, such as closings or inspections. The activity map module may be used by any permitted party accessing the System Access Module 170. Any information necessary or desirably to assist in managing the transaction can be displayed in the activity map by the activity map module 230. Additionally, individual users could customize their activity map to include or exclude prescribed information. Such customization by a user would preferably not affect other user's views.

As illustrated in FIG. 4, the activity map module 230 of the information managing and transferring system compiles the information from the folder module 220, and creates an activity map. The activity map is preferably a viewable schedule, showing such information as dates, business transaction related activities, and deadlines for the transaction related activities. The activity map can be generated manually by entering activities and their corresponding due dates, or automatically by generating activities and their corresponding due dates by propagating previously set instructions through an activity map based upon a previously recorded transaction's activity map or master activity map 410. The activity map module allows a user to add, change, or delete any aspect of an activity either individually for each client or for all clients uniformly. Preferably, only certain users will have the ability to change the information.

The master activity map 410 can be generated from a previously created activity map or can be generated manually and stored as a master activity map. For every seller or buyer, for example, many of the same activities occur and a master activity map 410 can be used to help define the process to aid a user in repeating the same steps for each client. Thus, items on a specific user's activity map could be populated from a prescribed master activity map. It should be understood that any number of master activity maps could be available, each one having different prescribed information.

The master activity map can, alternatively, be entered every time a new folder is entered into the system, whereupon the system can create a copy of the master activity map 410 for that client and can customize the master activity map 410 into a personalized activity map for a specific transaction. On the individual activity map 435, status information for an Agent and his/her client can be updated.

The activity map can also include “triggers,” which can be entered for general or specific due dates. For any given transaction, multiple hard and soft due date occur. Many of these dates can be automatically calculated based on information provided to the system by a user. The thusly calculated dates can then be automatically entered into the activity map. For example, the date that a contract is received is preferably entered into the system. The activity map can then automatically calculate and enter due dates of activities related to the contract. Similarly, dates for settlement activity or any other type of activity required in the business transaction can be generated. In addition to the automatically calculated due dates, follow-up reminder dates may also be set. The activity map also allows an Agent to follow the same path for every seller or buyer, but is not rigid and therefore can be adjusted. If a date is a hard due date, it is not changeable, whereas a soft due date is one that can be changed by a user after it is set. In the preferred embodiment, the two types of due dates are differentiated from each other by a visual cue, such as color.

The preferred activity map module 230 includes two individual activity maps and their respective modules. These are a seller activity map module 435a and a buyer activity map module 435b. Each activity map may include tasks to be completed on behalf of the respective seller or buyer. The activity maps could also be used to designate due dates and due tasks pertaining to a business transaction and may also contain, for example, reminders for activities, whether automatic or manually entered.

The activity map module 230 may include several modules communicatively coupled to an activity map access module 415. For example, the modules may include a service links module 445, a time zone adjuster module 400, and a master activity map(s) module 410. It may also include an individual activity map(s) module 435, including individual activity maps for a buyer 435a, for a seller 435b, a letter generator module 420, and an automatic calendaring module 425. It may also include a reminder generator module 430 and a graphical representations module 440.

The activity map module 230 may be used to record notes on a transaction or to create customized messages per activity or add staff instructions per activity. The activity map module may also display all work for an activity in a notes section, add and display notes for each activity map, or display activity maps which may be divided into submaps, which in turn may be individually customized for parties to a business transaction.

The activity map module 230 may also be used to add unique, ad hoc activities to individual activity maps 435, mark activities with the same or different date and the same or different status, or copy existing activity maps as a baseline in creating new master activity maps. Further, the activity map module 230 may also be used to add a service provider link to an individual activity, allow access by other users to other users, or display third-party activity maps. Additionally, the activity map module 230 may be used to view activity maps in list format in addition to graphical format, and create private activities which only specific users can access.

A service links module 445 may be provided within the activity map module 230 to provide information on business related service providers, such as inspectors, appraisers, contractors, etc., as well as the contact information for these providers. A time zone adjustor module 400 can also be provided within the activity map module 230. The time zone adjuster module 400 is used to adjust the activity map times for a specific business transaction to a different time zone, so that a specific time designated for a specific task can be properly identified regardless of the time zone in which a user is located.

A letter generator module 420 may also be included in the contact manager module 260. The letter generator module 420 is configured to generate letters in the form of, for example, printed communications, email, or facsimile communications to, for example, the Agent, buyer, seller, clients, or other parties which the user may wish to contact. Any form of communication could be supported by this module, and the above examples are not intended to be limiting.

An automatic calendaring module 425 may be used conjunctively with the activity map module 230. The automatic calendaring module 425 is preferably configured to enter dates and tasks into a calendar form as necessary or can automatically calendar other recurring or one time activities or messages from an activity map, as mentioned above. Calendar entries can also be manually entered or modified through the automatic calendaring module 425.

The activity map module 230 may also include a reminder generator module 430, which preferably operates in conjunction with the automatic calendaring module 425 and/or the master activity maps module 410 and/or the individual activity maps module 435 to create reminders of tasks, dates, and times. A letter generator may be utilized to create such reminders.

The activity map module 230 may also include an individual activity maps module 435, wherein an Agent or other user could enter any activities separate from the business transactions, such as a client specific matter. Additionally, the individual activity maps module 435 may be used to allow a client to view the entire transaction process, including activities a client is not involved in, as an Agent or other administrator deems appropriate. With the individual activity maps module 435, a client can be better prepared and have a deeper understanding of an Agent's activities, especially those that do not involve their client. Additionally the individual activity map module 435 can provide detailed and overview displays of upcoming and completed activities. Thus, a user can see all due dates, including those that have be completed as well as those that are still open. Additionally, all of the services provided by the Agent can be accessed by the client, thus allowing the client to prepare for upcoming activities.

The activity map module 230 preferably also includes a graphical representation module 440 to allow for any portion or all of the activity map module 230 to be displayed graphically. For example, graphical representations of upcoming dates and tasks could to be displayed via the graphical representation module.

In addition to the modules discussed above, other modules may be included in the activity map access module 230, such as a module configured to record notes on a transaction, one configured to add staff instructions per task or activity, or one configured to select either email or paper as a media for updating a client with regard to the tasks or activities. Additionally, other modules may also be included, such as one configured to create letter campaigns for each activity or task, one configured to add new activities as needed, one configured to allow Agents to view activity maps from a viewpoint of a client, one configured to convert the master activity maps into a list format, and/or one configured to allow an Agent to create private activities which only the Agent can view. Other modules may also be included based on the needs of a particular user, Agent, client, seller and/or buyer, etc. Thus, any module that assists in communication and information display and/or documentation could be added to the activity map module 230.

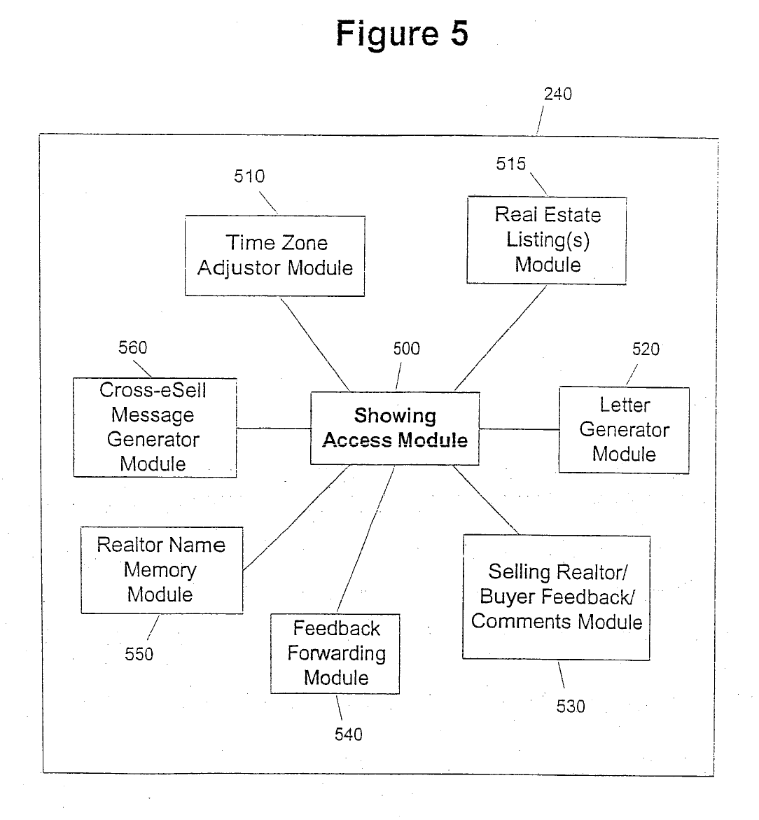

FIG. 5 illustrates additional details of the showings module 240. The showings module 240 may be configured to automatically send communications, such as email messages or facsimiles, to a party involved in a business transaction to request feedback from the party, or to advertise other business properties. Further, the showings module 240 may be configured to record any activity occurring at the product site. For example, if a selling Agent shows a product more than once, the listing Agent will know of the multiple visits, as well as any recorded information regarding the Agent, such as any previous visits to either a particular product or other properties visited in the past. The showings module 500 can also be used to provide feedback to a seller from a prospective buyer. For example, if a prospective buyer sees the seller's house and thinks the kitchen is outdated, the seller can then adjust the price taking this into account, or can remodel the kitchen. Additionally, a seller can use the showings module to compile a list of Agents who have shown a product and the seller can also broadcast messages to these Agents regarding price reduction or other updates, etc.

As illustrated in FIG. 5, a showings module 240 preferably includes several modules communicatively coupled through a showing access module 500. The time zone adjustor module 510 is similar to the time zone adjusting module 400 of the activity map module 230, and is used to ensure proper times are provided for a party located in a different time zone. The modules preferably include a time zone adjustor module 510 and a business listing(s) module 515. The showings module 240 may also include a letter generator module 520, a selling Agent/buyer feedback/comments module 530, and a feedback forwarding module 540. Additionally, the showings module may further include an Agent name memory module 550 and a cross-eSell message generator module 560. It should be understood that any other showings related modules could be provided as part of the showing module 240.

A business listing(s) module 515 may also be provided in the showings module 240. The business listing(s) module 515 is preferably configured to display a business product's information for a prospective buyer. Thus, time can be saved by allowing a prospective buyer to view all business listings available without the aid of the Agent. The prospective buyer benefits in that all properties can be seen without having to go to each product.

The business listing(s) module 515 also allows a prospective buyer to form a better idea of features sought in their ideal product, as well as allows the prospective buyer to discover neighborhoods that might include properties with those features. Also, both a prospective buyer and a buyer's agent, as well as a seller and a seller's Agent, would not have to coordinate schedules in order to provide a viewing to a prospective buyer. Rather, a prospective buyer can access product information at any time through the business listing(s) module 515. For example, the listing(s) module 515 could include a virtual tour of the product, including 360° view of all rooms.

The cross-eSell message generator module 560 is preferably used in a business transaction to automatically generate messages which can be sent to anyone through a letter generator module 520. The cross eSell message generator module 560 may be used in order to disseminate specific information via the Internet regarding a specific product. For example, the eSell module 560 may be used to automatically send a seller's agent an update regarding feedback information received from an interested buyer or buyer's agent. The cross-eSell module 560, then sends an e-mail to the interested buyer or buyer's agent thanking them for the feedback information. Finally, the cross-eSell module 560 may send a feedback to the buyer's agent regarding another product that better fits the buyer's agents specific needs or desires, according to the feedback information received.

The letter generator module 520 is thus preferably used in conjunction to the cross-eSell message generator module 560, and configured to automatically send the messages of the cross-eSell module 560 via email, facsimile, or printed letters to Agents, clients, buyers, sellers, or prospective clients to solicit feedback or to advertise other business properties.

Next, the selling Agent/buyer, or other customer feedback/comments module 530, is preferably used by a selling Agent, buyer or other customer to provide feedback or comments to a listing Agent to keep the listing Agent informed of any visits by a customer, selling Agent or buyer. Further, the feedback forwarding module 540 is preferably configured to forward the feedback or comments from the selling Agent/buyer feedback/comments module 530 to the listing Agent and/or the seller through the letter generator module 520. This increases both the ease of entry of feedback, as well as the accessibility to that feedback by all parties.

Showings module 240 may also include an Agent name memory module 550 preferably configured to record product visits by a particular Agent. Thus, if an Agent shows a product more than once, the listing Agent will know of the multiple visits, as well as any recorded information regarding the Agent, such as any previous visits to either a particular product or other properties visited in the past.

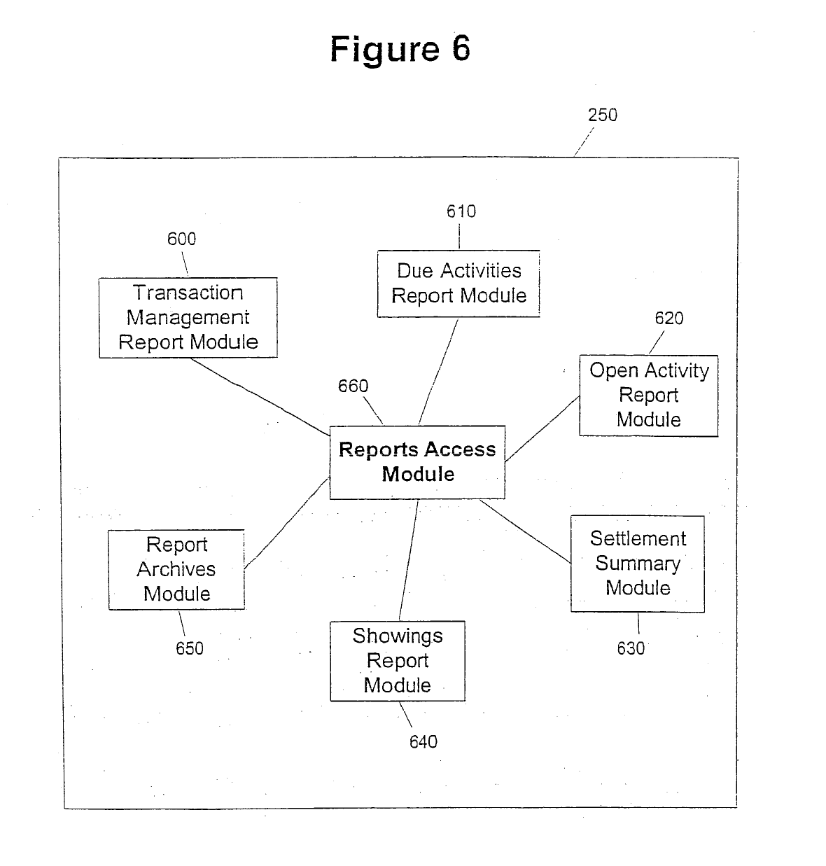

FIG. 6 shows additional detail of the reports module 250. The reports module 250 is preferably made up of a plurality of sub-modules that are communicatively coupled through the reports access module 660. The reports module 250 preferably generates information regarding a business transaction. This information includes activities due, settlement summary reports, or any reports regarding the transaction. The reports module 250 is further configured to generate other reports, including a listing of all transactions that are pending or that have been completed, and may further include any information regarding the transactions as necessary.

Each of the sub-modules will next be described. The reports module 250 preferably includes a transaction management report (TMR) module 600, a due activities report module 610, an open activities report module 620, a settlement summary module 630, a showings report module 640, and a report archives module 650.

The TMR module 600 preferably compiles information regarding business transactions. The TMR 600 may generate reports, including a listing of all transactions that are pending or that have been completed and may further include any other information regarding the transactions. Using the TMR 600, contingent due dates can be compiled from the start of a transaction through its completion. The TMR 600 may manipulate the information from any communicatively coupled module within the information management and transaction system can be compiled to generate reports on each and every transaction entered into the system based upon selected attributes by which the reports are based. These reports may be used as an overview of some or all of an Agent's business.

For example, using the due activities report module 640, due activities can be highlighted so that any and all critical tasks can be emphasized and displayed as a single report. Additionally, the due activities module 610 may display a report including all transactions in a calendar format which can include a daily, weekly or monthly format, as well as listing responsible parties for each activity. The due activities report module 610 may include any type of due activity for a business transaction or other activity. The open activities report module 620 may be used to compile lists of any activities which are open and have not been completed, or which have or have not been included in a due activities report.

Next, the settlement summary module 630 is preferably configured to list information regarding a settlement of a business transaction. For example, the settlement summary module 630 could list settlement dates, conditions, etc. The settlement summary module 630 may also show the dates and times of any upcoming settlement, thus eliminating the possibility of scheduling conflicts, such as having two closings back-to-back in different parts of town. This can also aid in allowing an Agent to approach each settlement completely prepared. The schedule can be provided in list, calendar or other desired form.

Next, the showings report module 640 may be configured to list the showings by a particular Agent, or showings of properties on specified dates, and any other showings information as necessary.

Finally, the reports archives module 650 preferably stores previously generated reports and can be used to archive reports or data entry from any of the modules communicatively coupled thereto.

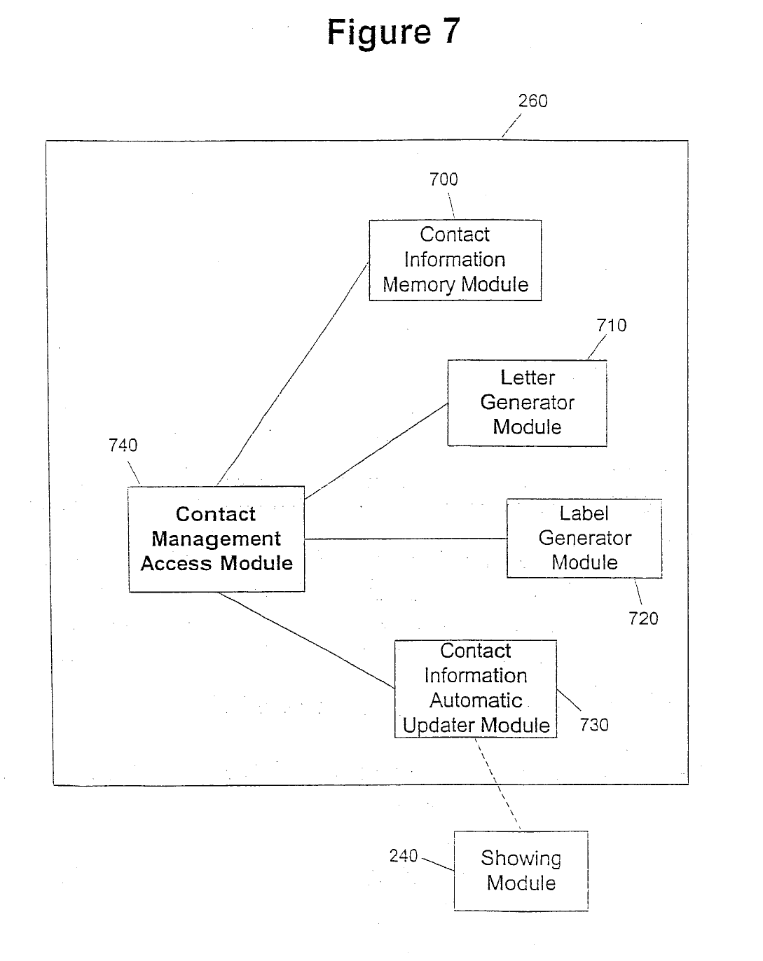

In addition to the above-mentioned modules, the information managing and transferring system according to the preferred embodiment of the invention also includes a contact management module 260 that can be used as a repository of any and all contacts and their information. As illustrated in FIG. 7, the contact management module 260 preferably includes several sub-modules that are communicatively coupled via a contact management access module 740. The sub-modules include a contact information memory module 700, a letter generator module 710, a label generator module 720, and a contact information automatic updating module 730.

Also, the contact management module 260 simplifies a users communication in a business transaction. Preferably, the contact information memory module 700 allows an Agent to disseminate information using electronic means. Information may be defined to include documents such as settlements, negotiations, and contracts. A user can receive, read and/or amend information using the Internet, PDA, electronic facsimile, or any other type of paperless communication. Furthermore, the contact management module 260 allows a user to sign and return a document using the Internet or any other electronic means. Preferably, the user can sign documents using an e signature. Thus, the contact manager module 260 allows for instantaneous communications.

The contact information memory module 700 preferably stores contact information of any parties to the contract, vendors necessary for the completion of the contract, other interested parties, anyone else with whom contact has been or will be made.

The contact management module 260 may also include a letter generator module 710, which may be used to merge prewritten form letters or personal letters with the contact information in the contact management module 260, where the letters are addressed and sent to parties using the contact management module 260. The contact management module 260 may also include a separate label generator module 720 configured, preferably, to generate labels with the contact information stored in the contact information memory module 700, of the contact management module 260. The letter generator module 710 can also be used for a letter campaign, where mass mailings can be sent to any or all of the contacts, including by groupings of contacts, in the contact management module 260, where each letter can be tracked to determined what letters have been sent to which contacts, as well as which letters are yet to be sent or yet to be opened.

Finally, the contact information automatic updating module 730 is preferably used either by the Agent or by any of the contacts, should the Agent desire to allow access, to automatically update information for the other modules of the system. The contact management module 260 may further include a repository of an Agent's listings or other contact information (not shown). Also, the contact information automatic updating module 730 can be linked to the contact information memory module 700 to allow for automatic updating of information as needed. The updated contact information can be added manually or from another source, such as e mails, Agent's listings, etc.

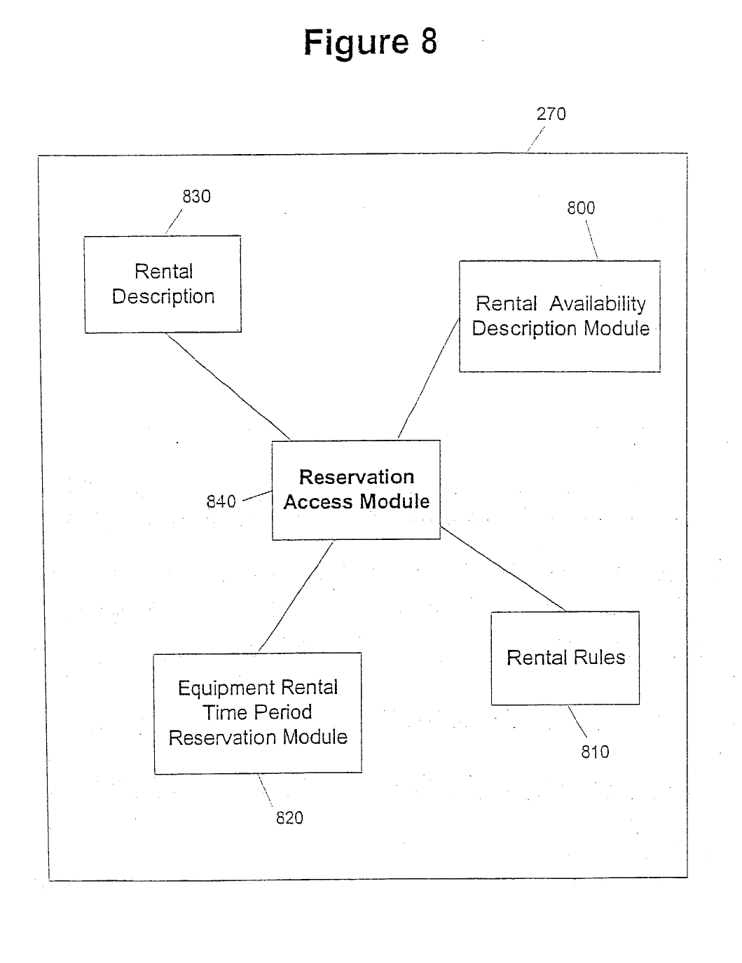

FIG. 8 illustrates additional details of the equipment reservation module 270. The equipment reservations made through the equipment reservation module 270 relates to items that a user may rent to a buyer or seller to facilitate a move to/from a product. The equipment reservation module 270 preferably includes a reservation access module 840 communicatively coupled to a rental rules module 810, a rental description module 830, a rental availability description module 800, and an equipment rental time period reservation module 820.

The rental rules module 810 preferably includes any applicable rules, such as the maximum time for which a person can rent the equipment, deposit requirements, etc. The equipment description module 830 may include information relevant to particular equipment available, such as the size of the equipment, the amount of deposit required, etc. The rental availability description module 800 may include a calendar or a listing configured to display available dates for which equipment may be reserved. Finally, the equipment rental time period reservation module 820 may include any reserved equipment time period.

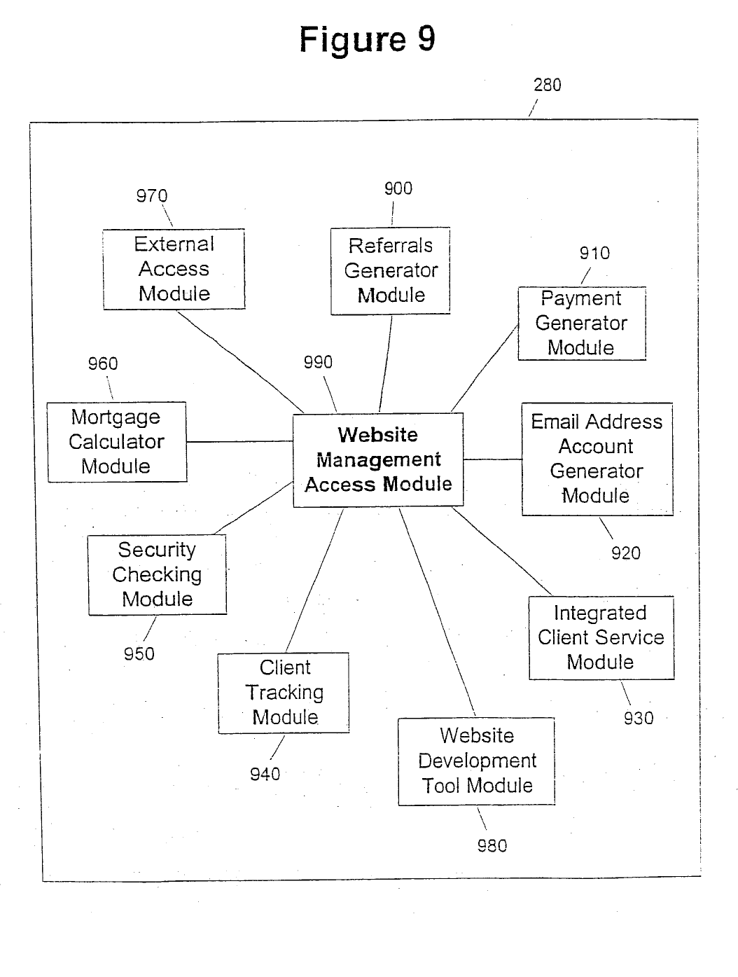

FIG. 9 shows additional detail of the website management module 280. The website management module 280 is preferably used by an Agent to control a website on which the network based system 110 is provided. The Agent may use the website management module 280 to add, change, or delete any properties of their website. The website management module 280 may also be used to make contact with potential new clients, allow control over individual folders, folder activity maps, individual contacts or change the accessibility rules or authorized users. The website management module 280 may also be used to allow the website owner Agent to pay for the costs of the system, post testimonials directly to the system, or track and date clients logged into an Agent's website. Further, the website management module 280 may allow an Agent interaction with system administrators, add or delete email accounts without intervention from system administrators, add unlimited numbers of levels of content, or add downloadable files to each of an Agent's website, use hyperlink files as sidebar titles.

The website management module 280 may be a template-based website development tool controlled by an Agent which can be used to add, change or delete any properties of their website. The website management module 280 may also be used to make contact with potential new clients, allow control over individual folders, folder activity maps, individual contacts or change the accessibility rules or authorized users.

The website management module 280 may also be used to allow the website owner Agent to pay for the costs of the system, post testimonials directly to the system or track and date clients logged into an Agent's website. Further, the website management module 280 may allow an Agent interaction with system administrators, add or delete email accounts without intervention from system administrators, add unlimited numbers of levels of content, or add downloadable files to each of an Agent's websites, use hyperlink files as sidebar titles.

The website management module 280 may also allow a user to require visitors to provide an email address or other pertinent identification prior to viewing any portions of the website or allow a user to link forms to other areas in their websites. Furthermore, the website management module 280 may also allow a user to grant service providers access to each service provider's contact information, allow a user to navigate a help system more easily, or allow a user to grant their clients access to each client's contact information.

The website management module 280 can also allow access to a mortgage calculator anywhere in the Agent's website, highlight the Agent's mailing address, display affiliate banners, allow for pictures to act as a website link, allow service providers to sign up directly on each Agent's website, print user manuals to take on listing appointments, or display all incoming leads posted to the Agent's inbox.

The website management module 280 can also allow service providers to add pictures to their entries, allow users online access to their account information, and allow users to designate different amounts to charge their respective service providers.

As illustrated in FIG. 9, the website management module 280 preferably includes a website management access module 990 that communicatively couples a referrals generator module 900, a payment generator module 910, an email address account generator module 920, an integrated client service module 930, a client tracking module 940, a security checking module 950, a mortgage calculator module 960, an external access module 970, a website development tool module 980, and/or any other website management module.

A referrals generator module 900 is preferably configured to make referrals of an Agent or a client to other service providers or to retail providers.

Next, the payment generator module 910 is preferably configured to collect payment or generate invoices for usage of the business transaction system.

The email address account generator module 920 is preferably configured to create, edit, or remove email addresses.

The integrated client service module 930 is preferably configured to provide client services, such as, to provide client user manuals to take on listing appointments, to automatically update information regarding the transaction or the parties to the transaction, and to automatically provide additional help to parties depending from interaction by the parties. Additionally, the integrated client service module 930 may also be used to customize forms with auto-responding email messages. For example, using the integrated client service module 930 prebuilt forms, such as requests for information or requests for services can be included. These “client-capture” forms can be used to find new clients, as well as allow prospective clients to communicate with the system administrator directly.

Next, the client tracking module 940 is preferably configured to determine whether a client has entered a website and if so where the client has accessed within the website, the time and frequency, as well as content.

Next, the security checking module 950 may be provided to deny entry to users who are not authorized to use the website.

The web site management module 280 may also include a mortgage calculator module 960 which is preferably configured to calculate monthly payments from the total cost of a business transaction and/or to calculate a total cost of a business transaction from a monthly allotment. An external access module 970 is also provided and is preferably configured to allow external access by an Agent, client, and/or other parties from any external site.

Next, a website development tool module 980 is provided and configured to control individual folders, activity maps or contracts, or allow Agents to interact with another party. The website management module 280 may also add or delete email accounts, add downloadable files, allow visitors to provide information, allow Agents to link forms to other areas, and/or display all incoming leads posted to an Agent.

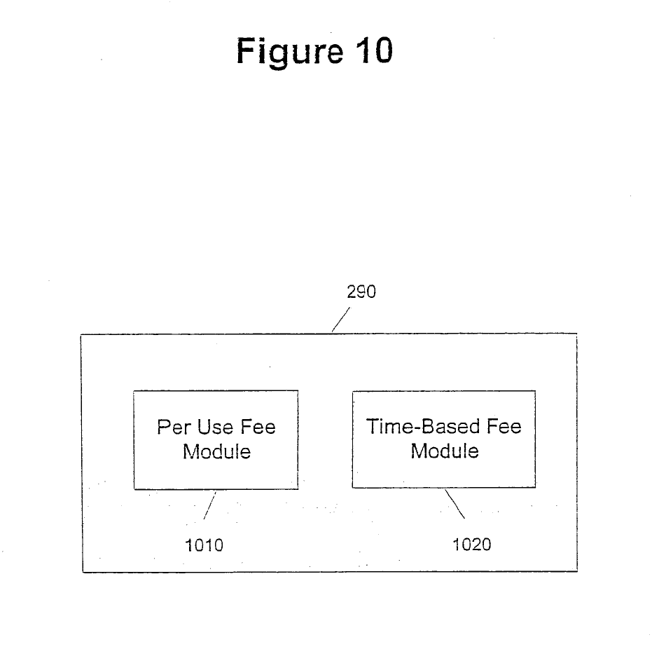

FIG. 10 illustrates additional details of the transaction fee coordinating module 290. The transaction fee coordinating module 290 preferably coordinates fees attributed to the business transaction. For example, the transaction fee coordinating module 290 may calculate expenses, generate invoices, or make automatic deductions from a user account.

As illustrated in FIG. 10, the transaction fee coordinating module 290 preferably includes a per use fee module 1010 and a time-based fee module 1020. Alternately, this module 290 may be replaced with a flat fee module, which generates invoices or makes automatic deductions based on a set fee.

The per use fee module 1010 may be configured to calculate fees, generate invoices, or make automatic deductions from an account based on a predetermined schedule of fees that may be levied. The time-based fee module 1020 may be configured to calculate fees, generate an invoice, or automatically deduct fees from an Agent based on a predetermined rate per unit time.

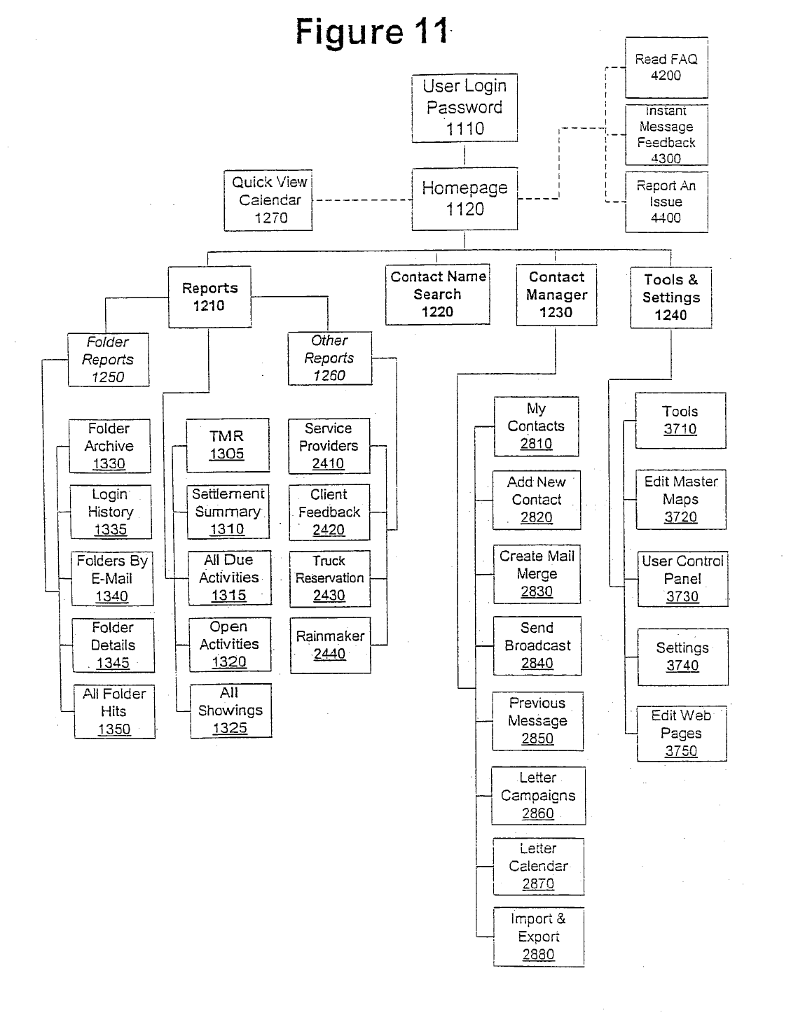

Next, a description of an operation of the web based management and transferring system will be provided. FIG. 11 illustrates an overview of the hierarchy of web pages accessible by an Agent according to the module system of the preferred embodiment.

Referring to FIG. 11, a network administrator may upload the information contained in the System Access Module 170 to a web page. The System Access Module 170 may be an interactive database that is accessed and updated via the Internet. The System Access Module 170 leads to a user name and password information (user login password) page 1110. The user name password information will allow the user to access specific information regarding business transactions. FIGS. 11-46 shows an Agent's view of a website, in accordance with an embodiment of the present invention.

Once the Agent has entered the website, the Agent may access various menus. For example, an Agent may access a reports menu 1240, a contact name search 1220, contact manager menu 1230, a tools and settings menu 1240, a folders reports 1250, and other reports 1260. Also included may be a search option to locate any database information by a specified search criteria, such as product name, contact name, e-mail address or contact address. A quick view calendar option 1270 may also be provided. Also included in the web based application may be an instant message help option 4200, a read FAQs option 4300, and a report an issue option 4400.

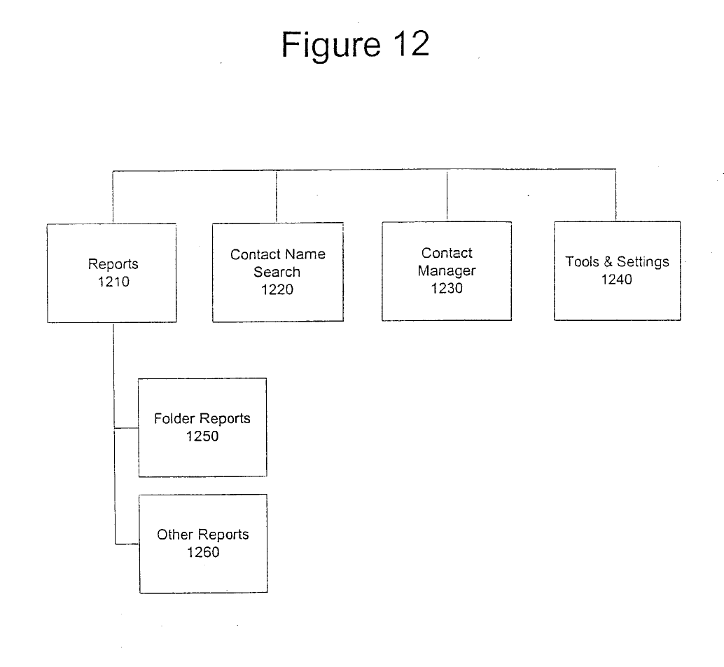

Each of the top level menus (reports 1210, contact name search 1220, contact manager 1230, tools and settings 1240 and other reports 1260), is preferably provided on each viewed web page as a drop down or scroll down menu (see FIG. 12). Each of the items on FIG. 11 is thus preferably a choice on a corresponding drop down or scroll down menu. This provides for easy navigation throughout the web site.

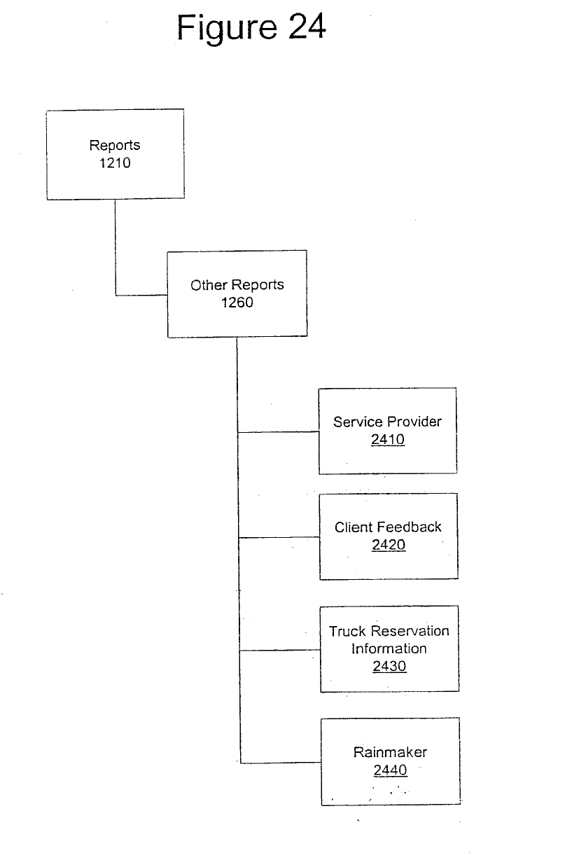

Thus, the reports menu 1210 includes a selection of transaction management reports information 1305, settlement summary information 1310, all due activities information 1315, open activities information 1320, all showings information 1325. The folder reports menu 1250 includes a selection of folder archive information 1330, login history information 1335, folders by e-mail information 1340, folder details information 1345, all folder hits information 1350. Also, the other reports menu 1260 includes a selection of service provider information 2410, client feedback information 2420, truck reservation information 2430, and rainmaker information 2440 (all shown in FIG. 24).

The contact manager menu page 1230 includes a selection of my contacts option 2810, add new contacts option 2820, create mail merge option 2830, send broadcast option 2840, previous messages option 2850, letter campaigns option 2860, letter calendar option 2870, and import/export option 2880.

Finally, the tools and settings menu, page 1240 includes a selection of tools option 3710, an edit master maps option 3720, user control panel option 3730, a settings option 3734, edit web pages option 3750, and a logout option 3760.

Additional detail regarding the website is next provided. Referring to FIG. 12, the web based system access module 170 contains a plurality of drop down or scroll down menu options that a user may select from. For example, the drop-down or scroll down menu options may include a reports menu 1210, a folder reports 1250, a contact manager menu 1230, an other reports menu 1260 (see FIG. 24), and a tools and settings menu 1240. Also included may be a contact name search option 1220 to locate any database information by a specific search criteria such as, by product name, contact name, email address or contact address. Also included may be a quick view calendar 1270.

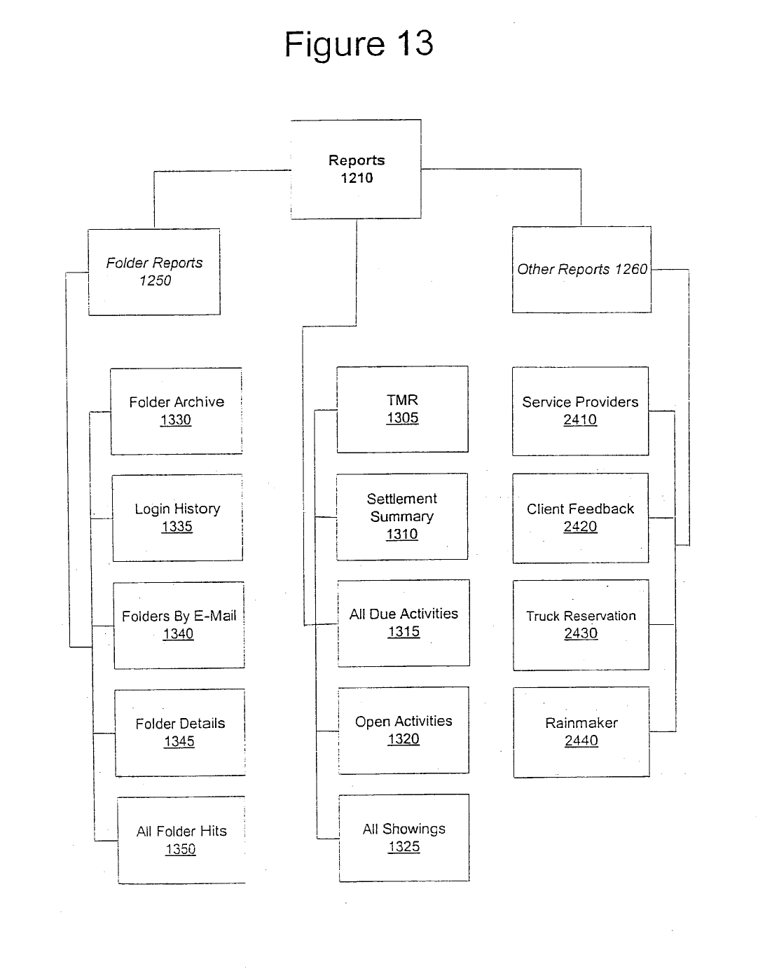

Additional detail regarding the reports menu 1210 is next provided. Referring to FIG. 13, once an Agent selects the reports scroll down menu 1210, a plurality of report type options may appear. This may include a transaction management reports (TMR) information 1305, settlement summary information 1310, all due activities information 1315, open activities information 1320, all showings information 1325, folder archive information 1330, login history information 1335, folders by email information 1340, folder details information 1345, and/or all folder hits information 1350.

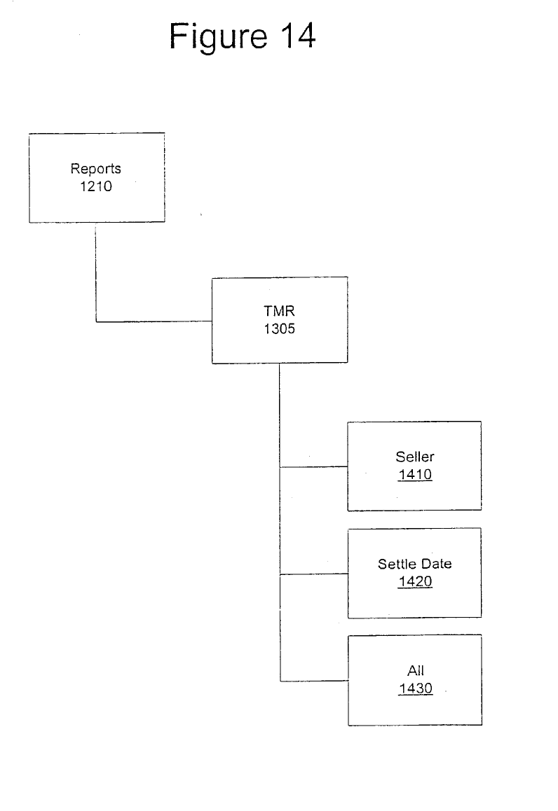

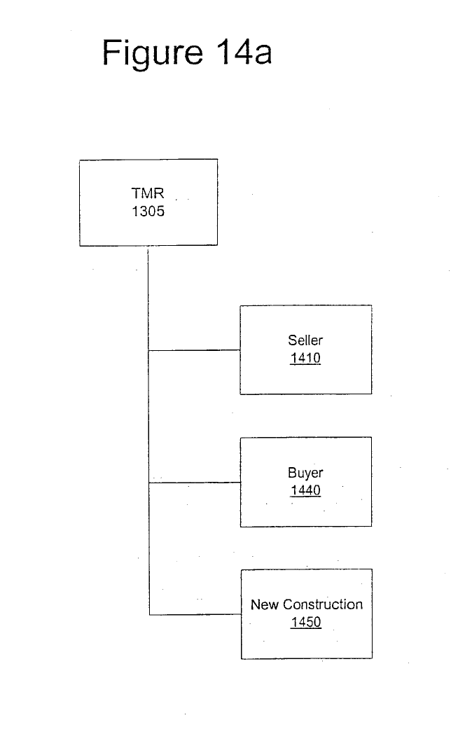

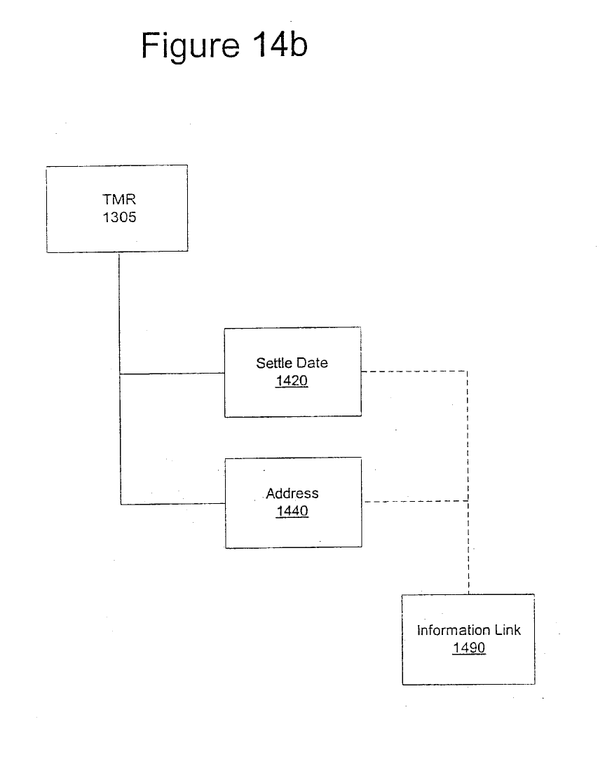

Additional information regarding the TMR information database option 1305 is next provided. Referring to FIG. 14, the TMR information database option 1305 contains information regarding business transactions. A TMR may be used to gather information from other areas of the database and sort that information. Also, the TMR may be used to generate reports which may include a listing of all transactions that are pending or that have been completed. It may further include any information regarding the transactions as necessary. Using TMR, all due dates, including contingent due dates, may be compiled from the start of a transaction through its completion. The TMR may be used to manipulate the information from any Agent's input or automatically from a database. The TMR can manipulate the information, then compile and generate reports based upon selected attributes by which the reports are based. These reports may be used as an overview of some or all of an Agent's business. The due dates may also be color coded, in order to identify whether urgent action is necessary by merely glancing at the web page.

Also, as shown in FIG. 14, within the TMR information database option 1305 are sub-drop down menus that may be selected to choose the type of report desired. The sub-drop down menus may include, as illustrated in FIG. 14a, a seller 1410, a buyer 1440, and a new construction 1450, or as illustrated in FIG. 14b, settle date 1420, or address 1470. The sub-drop down menus allow the user to find or organize information based on certain criteria as defined by the user. Also included is an information link option 1490, which provides a short cut to important information regarding a specific date and transaction. The information may be gathered from anywhere in the database.

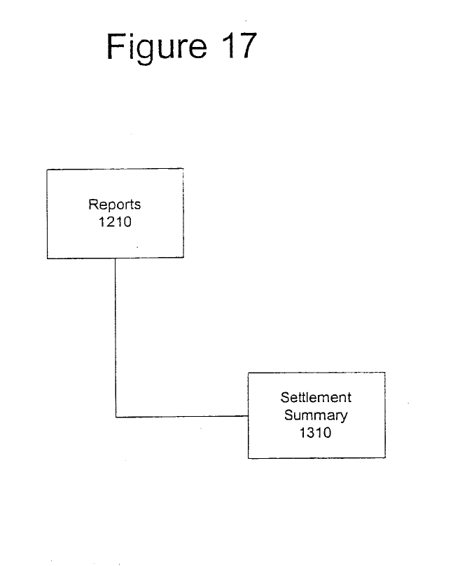

Additional information regarding the settlement summary option 1310 is next provided. As shown in FIG. 17, a settlement summary option 1310 may be selected from the reports drop down menu 1210. The settlement summary option 1310 may be configured to list information regarding a settlement of a business transaction, for example, settlement dates, conditions, etc. The settlement summary option 1310 may also show the dates and times of any upcoming settlement, thus eliminating the possibility of a scheduling conflict, such as two back-to-back closings of in person contracts in different parts of town. This can also aid in allowing an Agent who must be present to approach each settlement completely prepared. The schedule information can be provided in a list, calendar or other desired format.

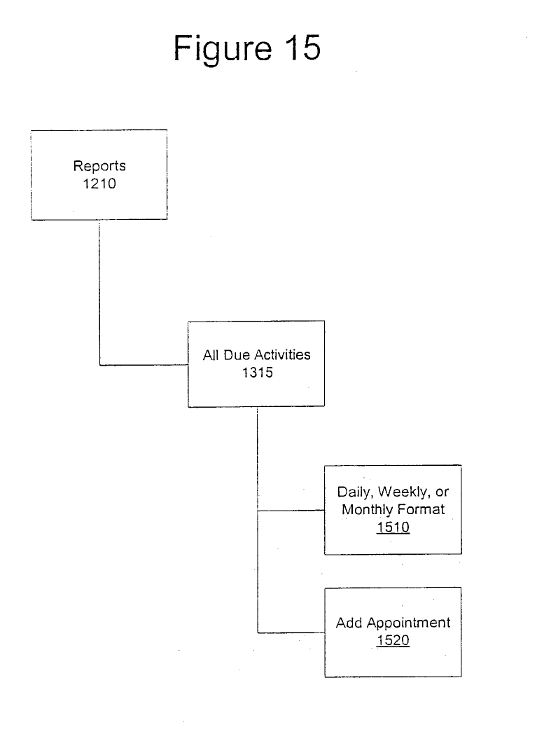

Additional detail regarding the all due activities option 1315 is next provided. As shown in FIG. 15, the all due activities option 1305 may be selected from the reports scroll down menu 1210. The all due activities option 1315 displays any and all critical tasks. The all due activities option 1315 may be displayed in a calendar format, which can include a daily, weekly or monthly format 1510. Additionally, it can display responsible parties for each activity. Furthermore, the all due activities calendar format may be color coded based on the user entering the system, or based on a completed/due/overdue/not due status. Also, the all due activities option 1315 allows a user to add appointments 1520 according to open calendar dates.

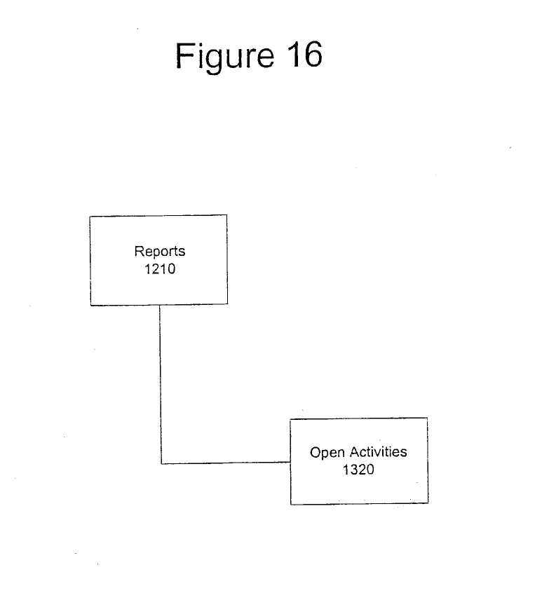

Additional detail regarding the open activities option 1320 is next provided. Referring to FIG. 16, the open activities option 1320 may be selected from the reports scroll down menu 1210. The open activities option 1320 may include any type of due activity for a business transaction or other activity. The open activities report option 1320 may be used to compile lists of any activities which are open and have not been completed regarding any business transaction, or which have or have not been included in a due activities report.

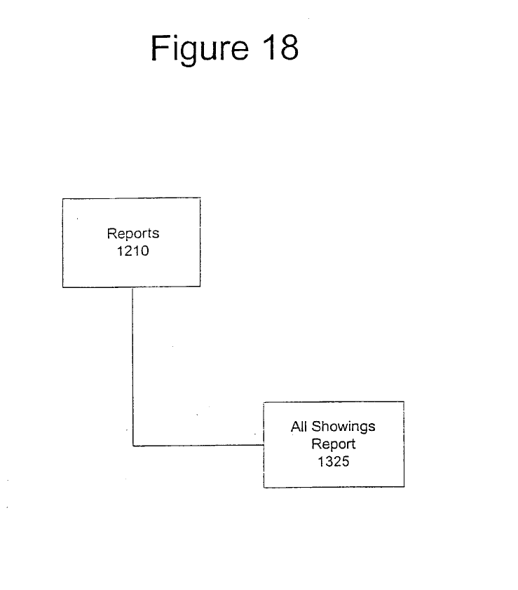

Additional information regarding the all showings report option 1325 is next provided. Referring to FIG. 18, an all showings report option 1325 may be selected from the reports drop down menu 1210. The all showings report option 1325 may be configured to list all inventory, other business item or in person transaction meetings of a particular Agent and any other information as necessary. Also, the all showings information option allows a user to see what parties are interested in specific inventory. This may also include how many times the product was visited on the web site, in a store, etc.

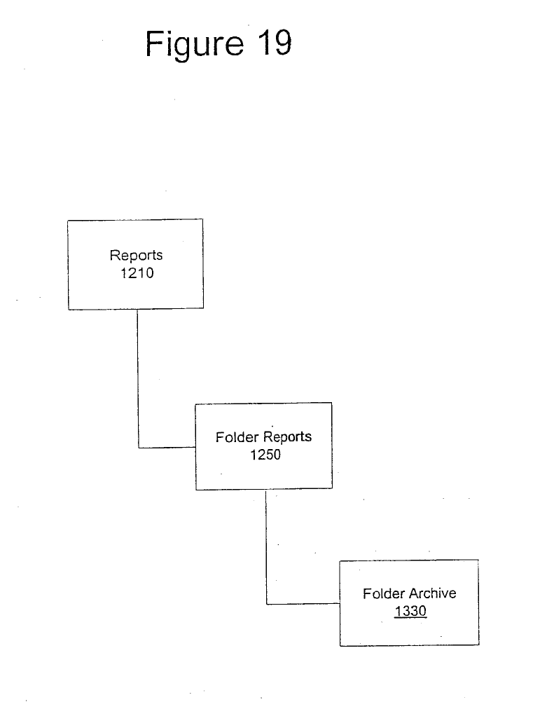

Additional information regarding the folder archive option 1330 is next provided. Referring to FIG. 19, the folder archive option 1330 may be selected from the reports drop down menu 1210. The folder archive option 1330 is used to store processed information necessary for a past business transaction, such as selling price, transaction completion date, model type or number, street address, Agent, etc. Other information could also be included here.

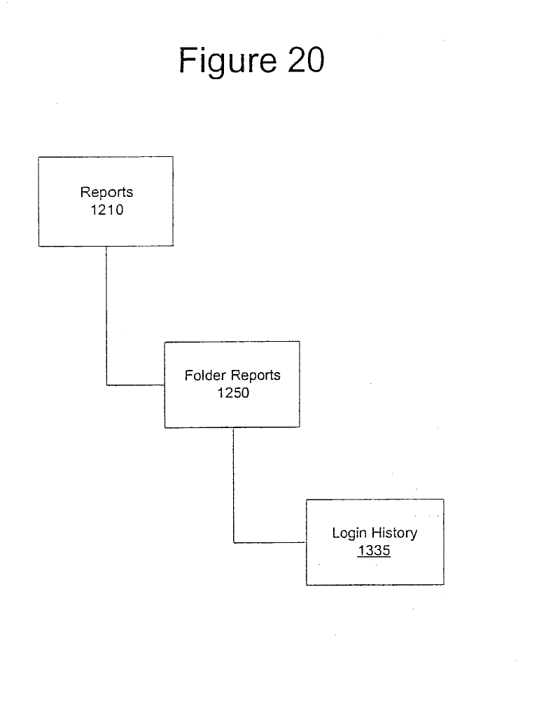

Additional detail regarding the login history option 1335 is next provided. As shown, in FIG. 20, the login history option 1335 may be displayed after being selected from the reports drop down menu 1210. The login history option 1335 provides detailed information regarding a user's login time and activity in the website. This information is preferably saved.

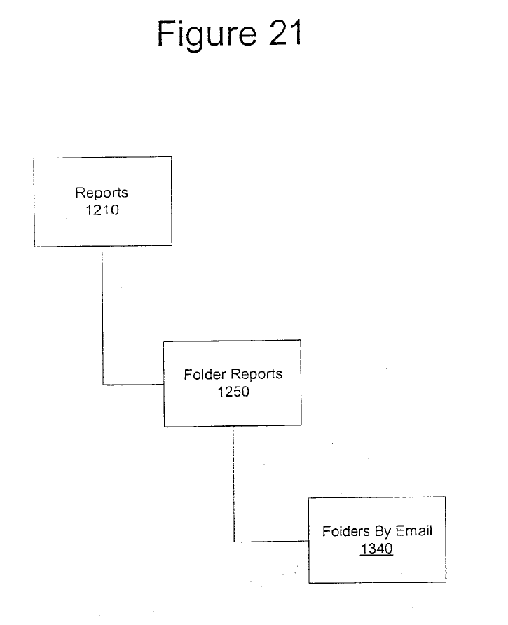

Additional detail regarding the folders by mail option 1340 is next provided. As shown in FIG. 21, a folders by email option 1340 may be selected from the reports drop down menu 1210. The folders by email option 1340 allows a user to search contact information regarding a party to a business transaction by an e-mail address assigned to that user.

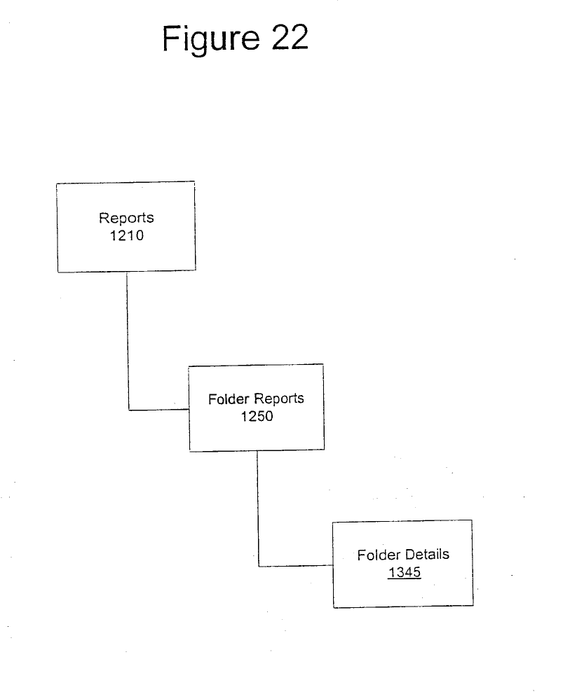

Additional information regarding the folders detail option 1345 is next provided. As shown in FIG. 22, the folders detail option 1345 may be selected from the reports drop down menu 1210. Within the folders detail option 1345 there is activity information related to a business transaction. The folders detail option 1345 may be displayed in calendar format and also may be color coded to identify the user's specific tasks or a due/not due status. The calendar format preferably includes an activities schedule with dates, business transaction related activities, and deadlines for the estate transaction related activities. Further, the folder detail option 1345 may store dates, times, and locations of important meetings regarding any aspect of a business or transaction, such as completion dates for transactions or inspections of products. The calendar may automatically generate activities and their corresponding due dates by propagating previously set instructions through an activity map based on a user's input. The folder details option 1345 allows a user to add, change, or delete any aspect of an activity either individually for each client or for all clients uniformly.

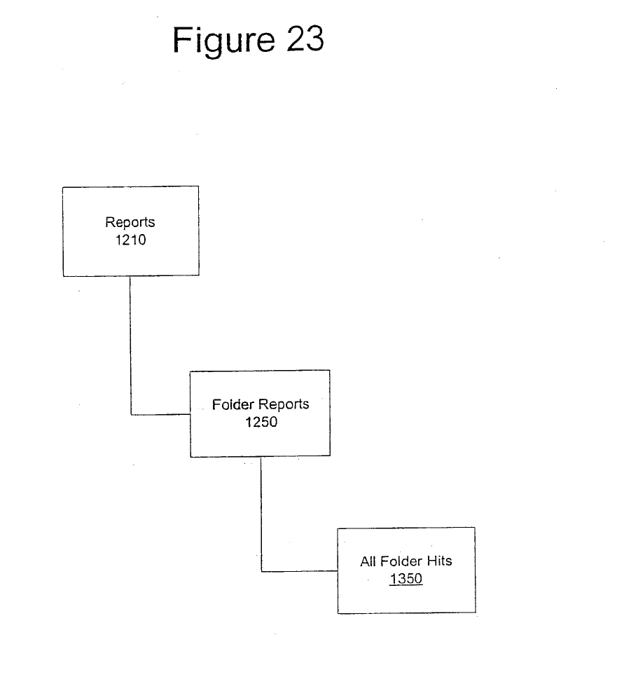

Additional information regarding the all folder hits option 4350 is next provided. As shown in FIG. 23, the all folder hits option 1350 may be selected from the reports drop down menu 1210. The all folder hits option 1350 provides information regarding the number of times a certain product was visited via the Internet.

Additional detail regarding the other reports menu 1260 is next provided. Referring to FIG. 24, once a user selects the other reports scroll down menu 1260, a plurality of other reports options appear. This may include a service provider option 2410, a client feedback option 2420, and a truck reservation menu 2430, and a rainmaker option 2440.

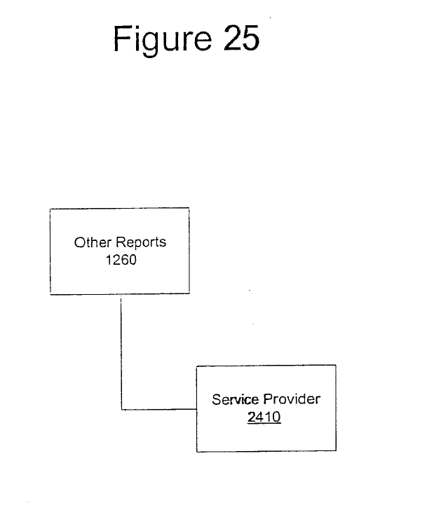

Additional information regarding the service provider option 2410 is next provided. FIG. 25 shows the service provider menu provided by the option 2410. The service provider menu allows access to an information database which allows an Agent to supervise and remain updated on which service providers have completed any tasks assigned and if any comments were made regarding the Agent or service provider. For example, the user may be able to see home inspection information, such as price of home inspector, and comments by the home inspector. Also, the service provider directory allows a user to add a service provider when that information is made available.

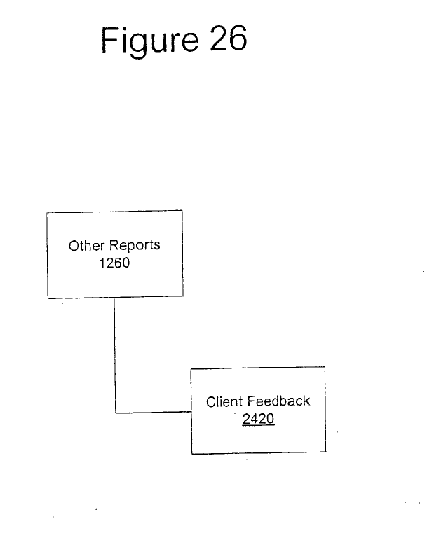

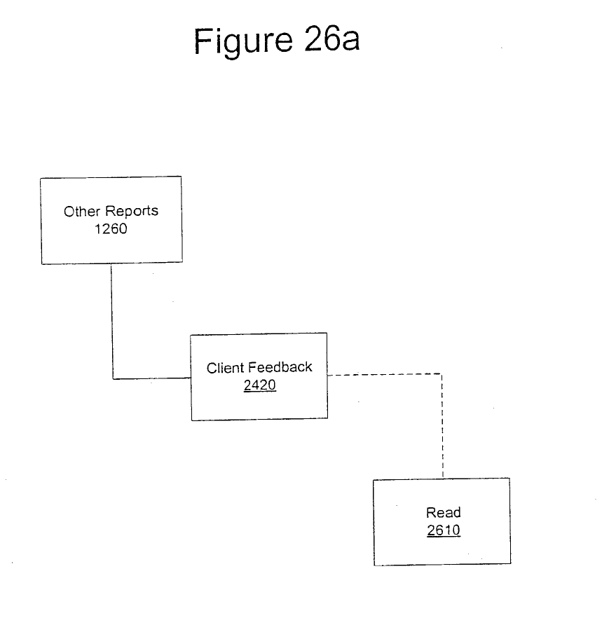

As shown in FIG. 26, the “client feedback information” option 2420 may be selected from the other reports scroll down menu 1260. The client feedback information database allows a selling Agent, buyer or other customer to provide feedback or comments to a listing agent and/or seller to keep the listing agent and/or the seller informed of any visits by a customer, selling Agent, or buyer. A feedback forwarding form may also be included and may be configured to forward the feedback or comments from the feedback/comments module to a listing agent and/or the seller through email, facsimile, or letter. This increases both the ease of entry of feedback as well as the accessibility to that feedback by all parties.

As shown in FIG. 26A, when a user selects a “read” link 2610 (as shown in FIG. 26) on the my client feedback option 2420, a client feedback form automatically appears on the screen for a client to complete. The completed client feedback form may then be viewed by a service provider, Agent, seller, or any other interested party specifically mentioned in the feedback. This allows the user to view comments the client has entered and view any ranking information. Ranking information may include a 1 to 5 ranking system with an optional scale, for example, 1 being “okay” and 5 being “excellent.”

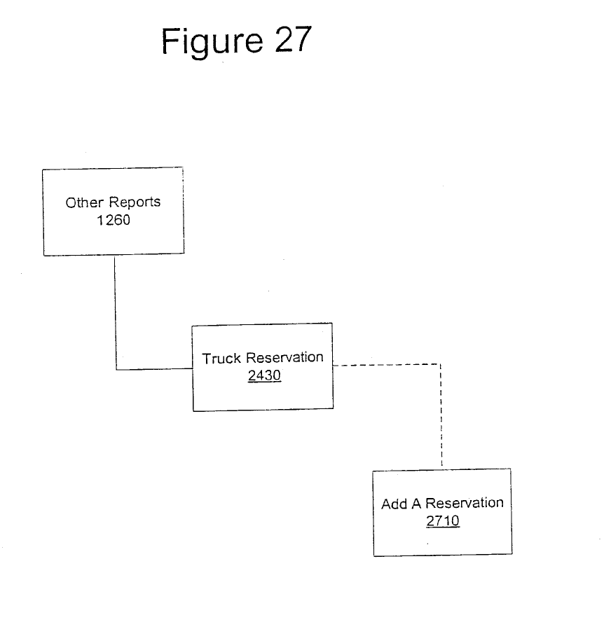

As shown in FIG. 27, the “truck reservation information” option 2430 may be selected from the other reports scroll down menu 1260. The truck reservation information database includes information regarding rental rules, equipment description, equipment availability, and equipment time period reservation. The truck reservation information database may include a form, which a user can fill out to reserve a truck. The truck information database also allows a user to add a reservation 2710.

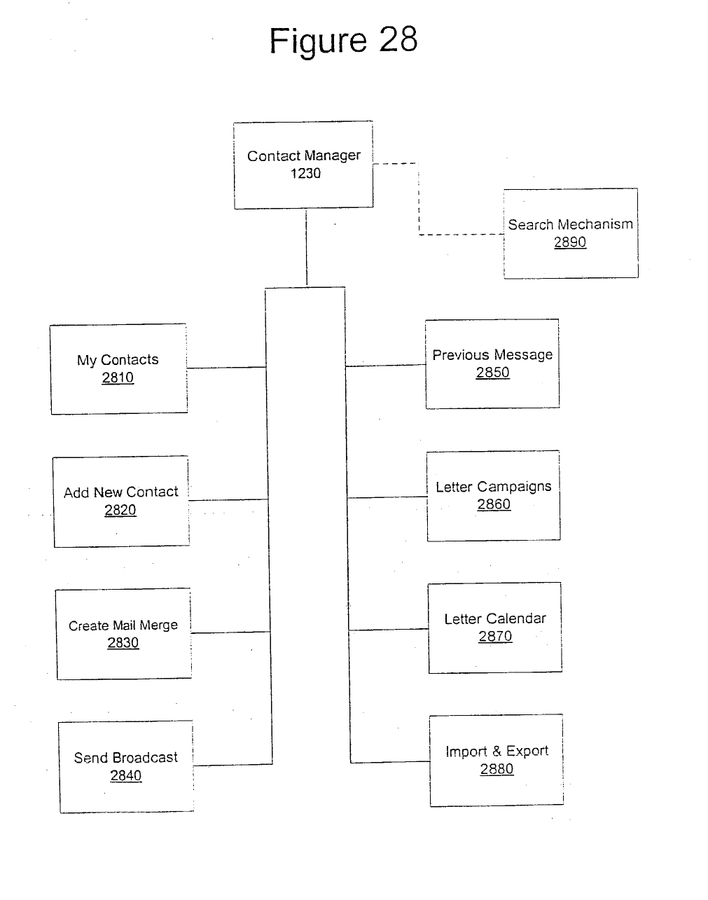

Additional information regarding the contact manager drop down menu 4230 is next provided. FIG. 28 shows the contact manager drop down menu 1230. The contact manager drop down menu includes information database options, such as a “my contacts” option 2810, an “add new contacts” option 2820, a “create mail merge” option 2830, a “send broadcast” option 2840, a “previous messages” option 2850, a “letter campaigns” option 2860, a “letter calendar” option 2870, and an “import/export” option 2880.

Furthermore, the contact manager drop down menu 1230 of the system access module 170 provides information regarding vendors, service providers, inspectors, insurance agents, and Agents contact information. The contact management drop down menu 1230 may also contain a search mechanism wherein the user enters a contact name 2890 to be automatically searched to locate the contact person's information.

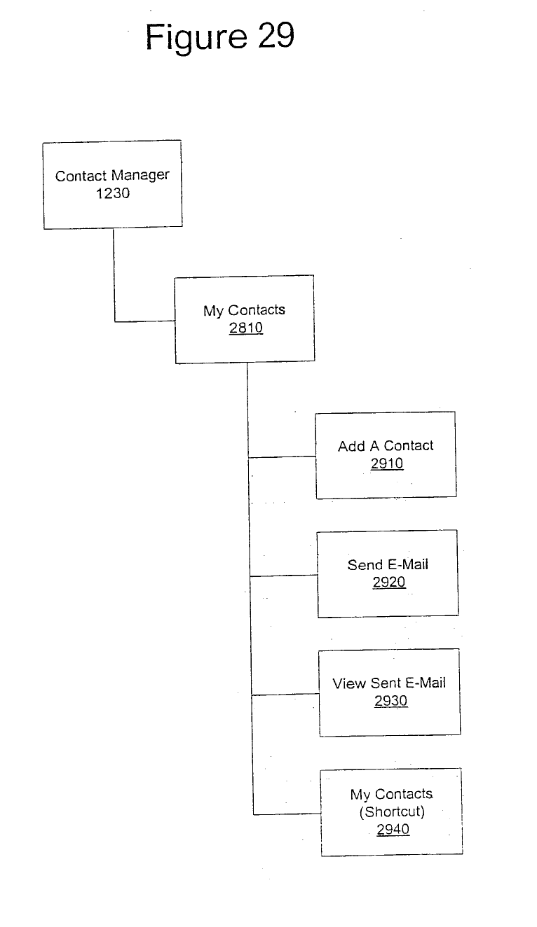

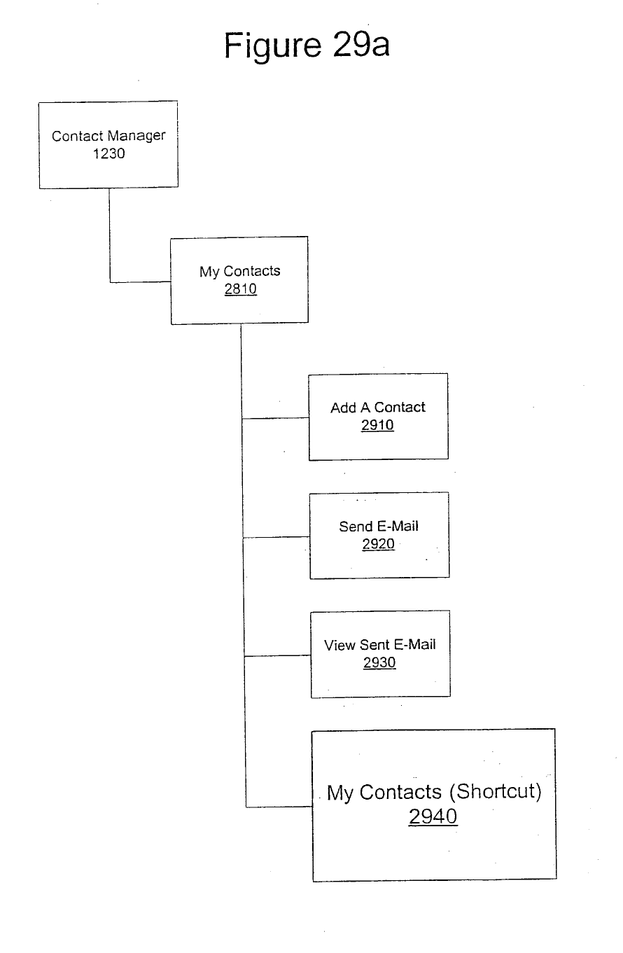

Additional detail regarding the “my contacts” option 2810 is next provided. As shown in FIG. 29, the “my contacts” option 2810 may be selected from the contact management drop down menu 1230. The user may customize contact information by selecting the “my contact” information database option 2810. Furthermore, the “my contacts” information database option 2810 allows a user to add new contacts 2910, send email messages to a contact 2920, and view sent emails 2930, and shortcut to my contacts option 2940.

Additional information regarding the shortcut to my contacts 2940 is next provided. As shown in FIG. 29a, the shortcut to my contacts option 2940 is a hyperlink that is always available on the web page during an Agent's navigation. This allows the Agent to quickly access any client contact information.

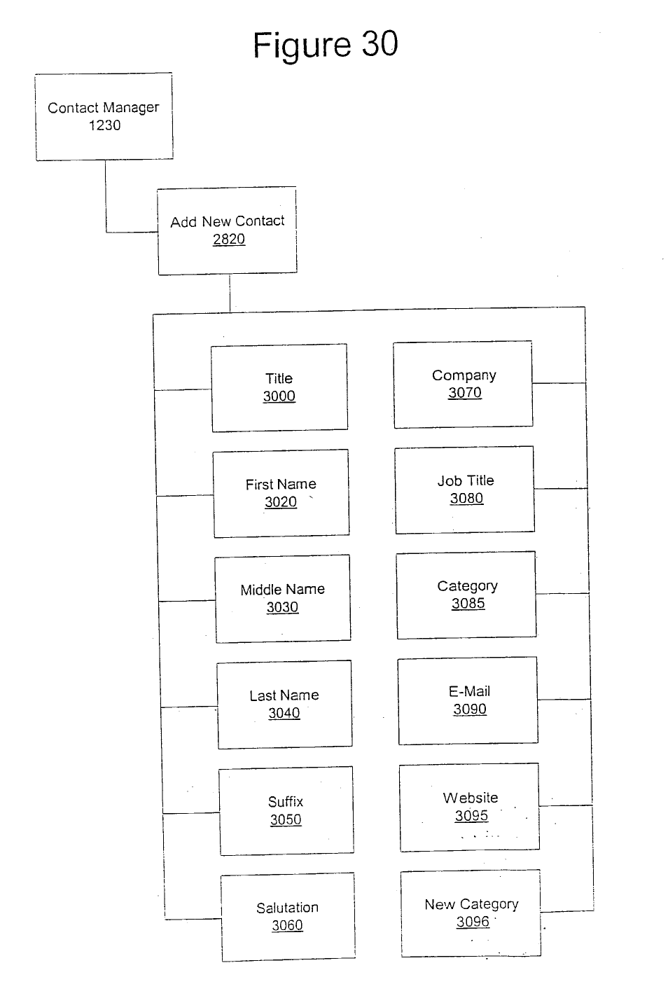

Additional information regarding the “add new contacts” option 2820 is next provided. As shown in FIG. 30, the “add new contact” option 2820 may be selected from the contact management drop down menu 1230. The “add new contacts” option 2820 is a graphical user interface, which allows a user to enter personal and business information about a contact. Such information may include title 3000, first name 3020, middle name 3030, last name 3040, suffix 3050, salutation 3060, company 3070, job title 3080, category 3085, email 3090, website 3095, and/or new category 3096.

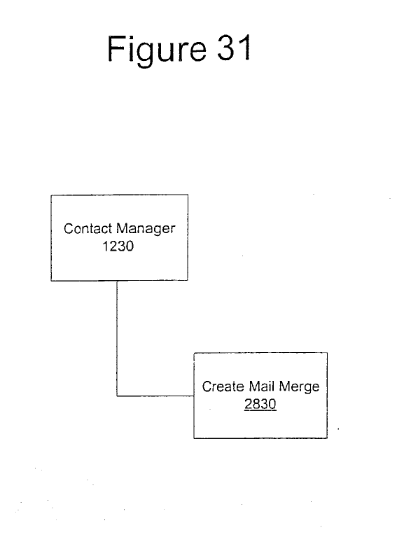

Additional information regarding the “mail merge” option 2830 is next provided. As shown in FIG. 31, the “mail merge” option 2830 may be selected from the contact management drop down menu 1230. The mail merge information database may be used to create printable labels for selected contacts. The user may select a date and format as the user desires, then select the contact the user wants to send the letter to. The “mail merge” option 2830 may be configured to automatically add the date, address, and salutation.

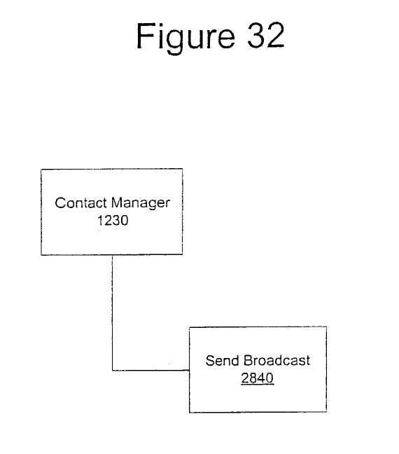

Additional information regarding the “broadcast alert message” option 2840 is next provided. Referring to FIG. 32, the “broadcast alert message” option 2840 may be selected from the contact management drop down menu 1230. The send broadcast information database may be used to create, send, and track emails to contacts, agents, seller, buyers, and Agents.

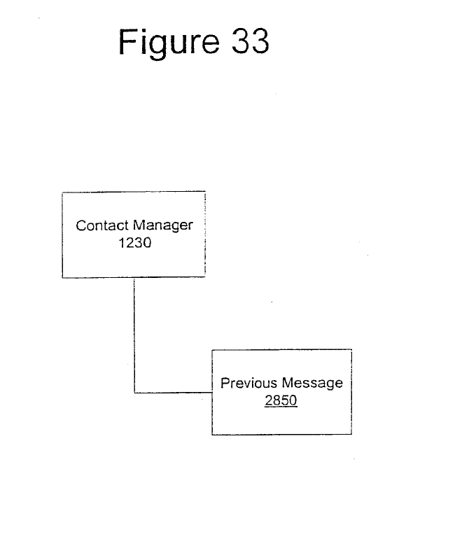

As shown in FIG. 33, a “previous email” option 2850 may be selected from the contact management drop down menu 1230. A user may view any sent email messages using the previous email option.

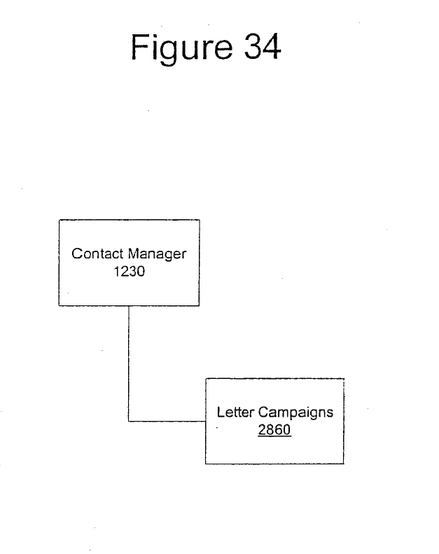

As shown in FIG. 34, a “letter campaigns” option 2860 may be selected from the contact management drop down menu 1230. The “letter campaign generator” option 2860 maintains forms that may be automatically generated to produce generic forms such as, client letters, service provider letters, and Agent letters.

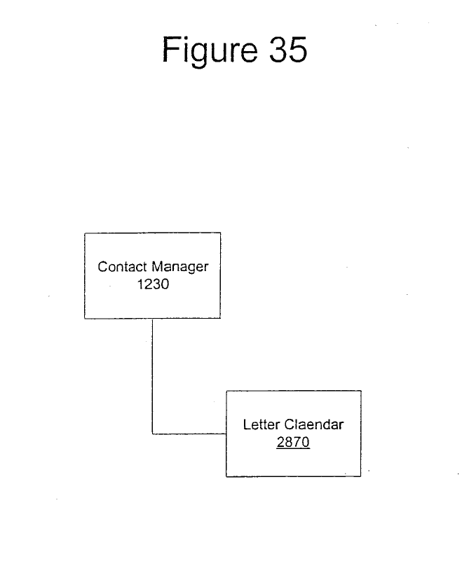

Additional detail regarding the “letter calendar” 2870 is next provided. Referring to FIG. 35, a “letter calendar” 2870 may be selected from the contact management drop down menu 1230. The “letter calendar” 2870 can be used to assign and docket dates and/or other call up information wherein a correspondence or reminder must be sent to the user, or other party involved in a business transaction.

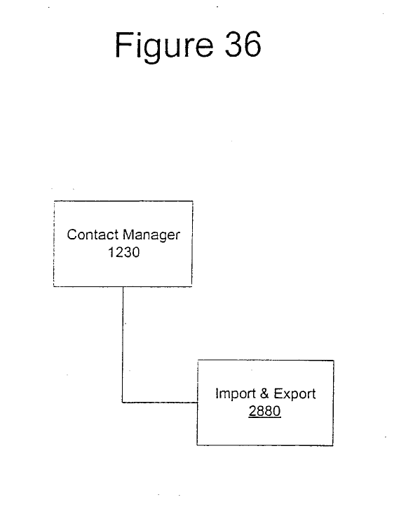

As shown in FIG. 36, the “import & export” option 2880 may be selected from the contact management drop down menu 1230. The “import & export” option 2880 allows a user to export all contacts mailing addresses to a spreadsheet. The user may select a link that will open a page containing all the contacts once the pages finished loading the user needs to save the page using the browsers toolbar and, preferably, saved as an HTML file. This allows a user to have all the database information without being logged onto the Internet.

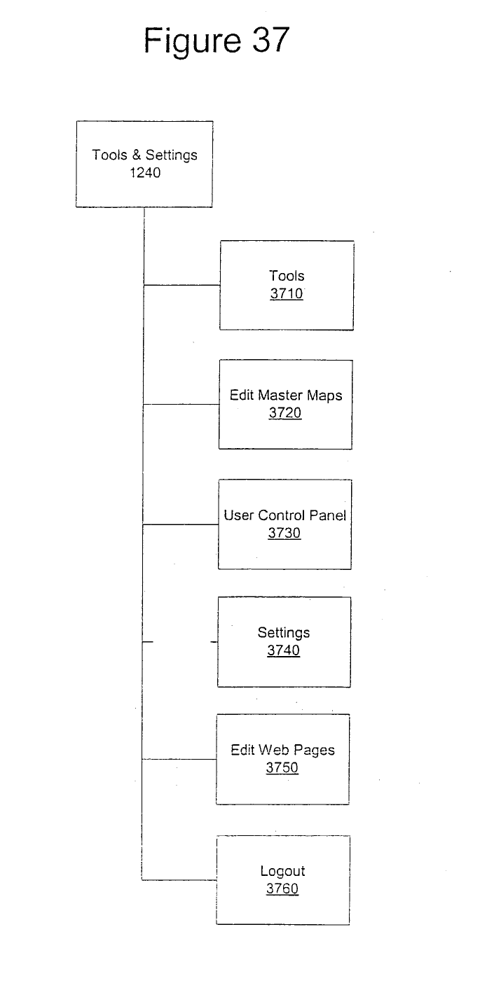

As shown in FIG. 37, the “tools and settings” drop down menu 1240 allows the user to customize a web page viewing of any folders within the folder module. The “tool and settings” drop down menu 1240 may also include a tools option 3710, an edit master maps option 3720, a user control panel option 3730, a settings option 3740, an edit web pages option 3750, and a logout option 3760.

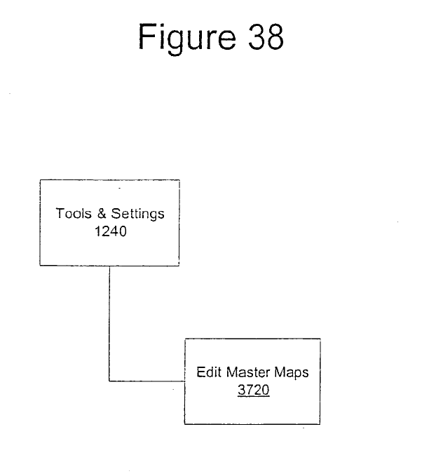

As shown in FIG. 38, the “edit master map” option 3720 may be selected from the “tools and settings” drop down menu 1240. The “edit master map” option 3720 may be used to edit any calendaring function specific to the user.

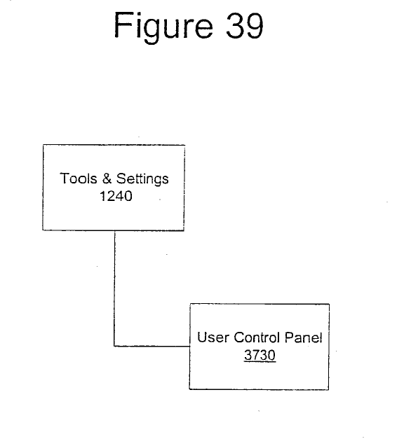

As shown in FIG. 39, the “user control panel” option 3730 may be selected from the “tools and settings” drop down menu 1240. The “user control panel” option 3730 may be used to limit or increase website access or allow certain users to have more administrative authority over the website.

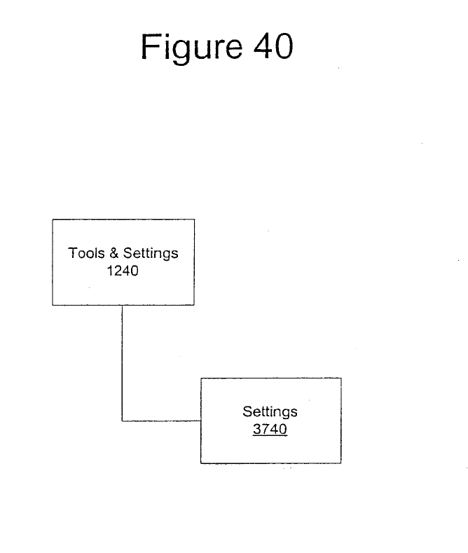

As shown in FIG. 40, a “settings” option 3740 may be selected. The “settings” option 3740 allows an Agent to customize the website according to their needs. For example, once an Agent has been given authority via the user control panel 3730 to make changes an Agent may customize the website using the “setting” option 3740.

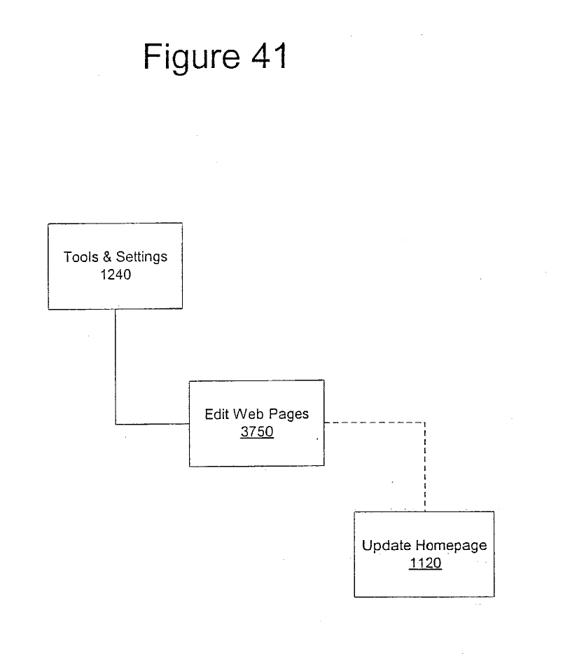

As shown in FIG. 41, an “edit web page setting” 3750 may be selected. The “edit web pages” 3750 allows an administrator, with authority, to update the homepage 1120, which is viewed by third party users, such as clients.

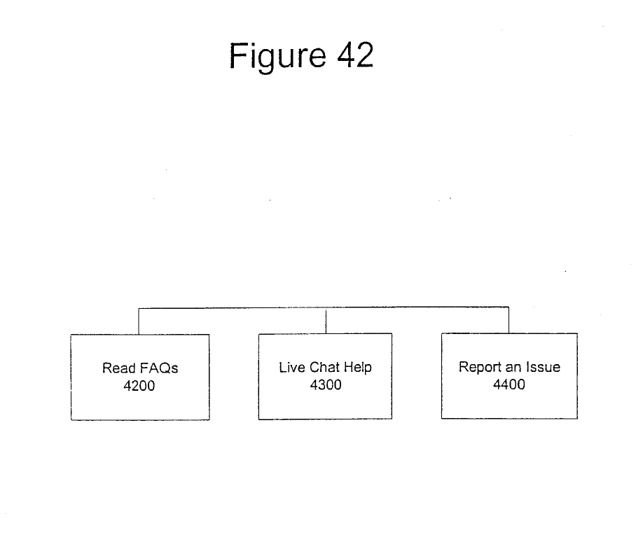

Also provided on the website are user help options. As shown in FIG. 42, the website may include read FAQS (frequently asked questions) option 4200, live chat help option 4300, and report an issue option 4400. These options allow a user to receive assistance from an administrator in real time or from a static database.

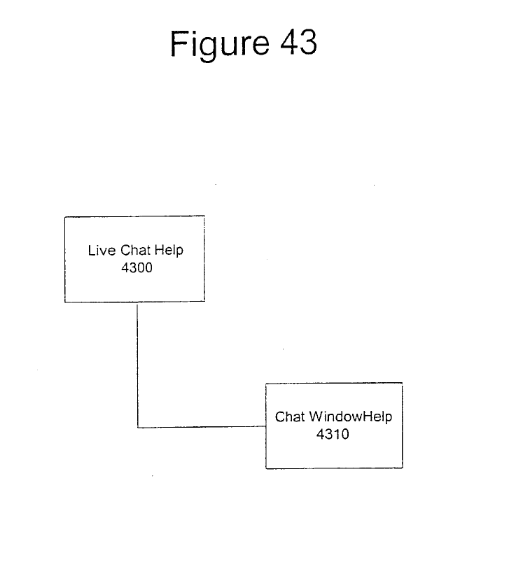

Additional detail regarding the live chat help 4300 will be described herein. As shown in FIG. 43, a user may select an instant message feedback option 4300 from a web page. The instant feedback option 4300 may be used to instantaneously provide answers to a website user's questions, from an administrator. For example, if a user is unable to access certain information, the user can instantly communicate with the administrator. The administrator can then communicate instructions to the user, or take control of the user's mouse, in order to navigate to the desired location on the site.

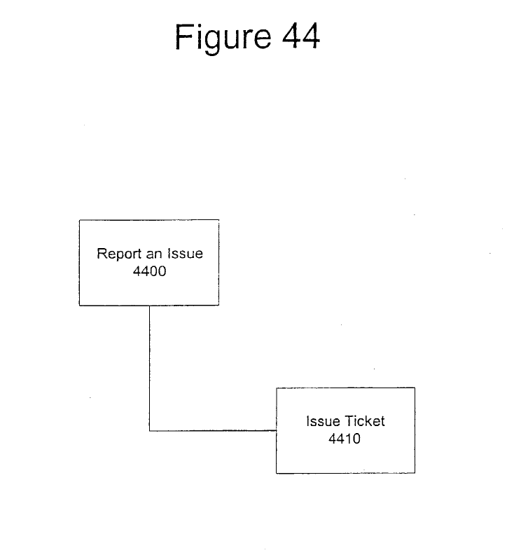

Additional detail regarding the report an issue option 4400 is next provided. As shown in FIG. 44 a website user may fill out an issue ticket form 4410, which is used to identify any problems with the website. The issue ticket form 4410 can then be sent to inform an administrator of the problem.

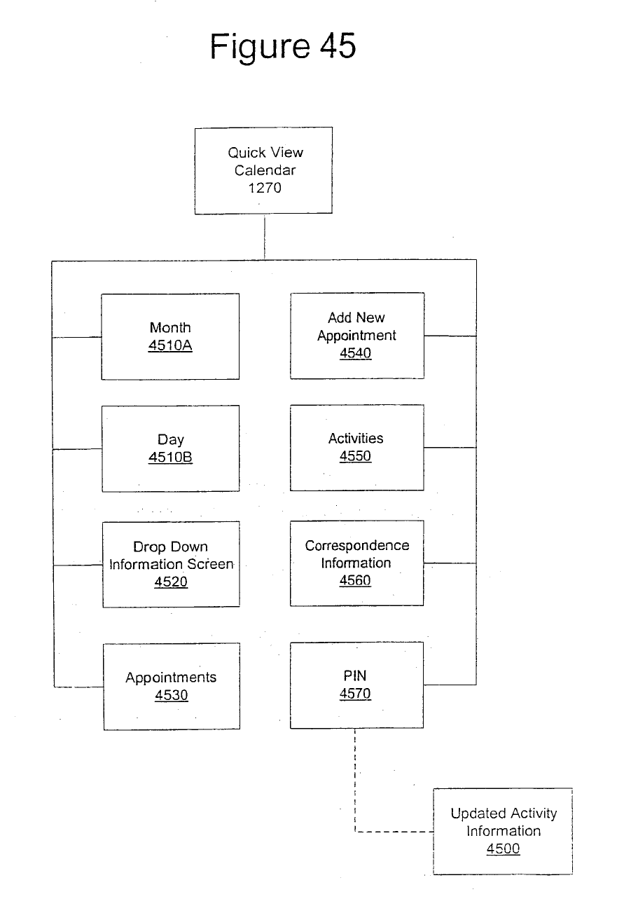

Additional information regarding the quick view calendar 1270 is next provided. As shown in FIG. 45, the quick view calendar 1270 is preferably available on the web page throughout a user's navigation of the web page. The calendar dates can be organized by month 4510A and/or day 4510B. Preferably, once the calendar month 4510A and day 4510B are selected, a drop down information screen 4520 appears. The drop down information screen 4520 may include information such as information relating to appointment for the day 4530, activities for the day 4550, and information concerning any correspondence generated or sent 4560. Additionally a user can add appointments for the day by selecting an icon to add new appointments 4540. Also, a pin 4570 or other mechanism to maintain the presence of certain information may be selected to maintain the drop down information on the screen while navigating through the website or may be deselected to close the drop down screen while navigating through the system. Additionally, the pin 4570 may be used to keep updated activity information 4500 on the screen while a user navigates through the website.

Alternatively, the website may be viewed from a client's view point. A client may be restricted to specific information regarding the business transaction. The client view allows a client to see information specific to the client. For example, an Agent may send an e-mail with a URL directing the client to their information. The client may access the URL directly from the e-mail. Once the client has entered a predetermined user name and password information, the client may then access their personalized business transaction information.

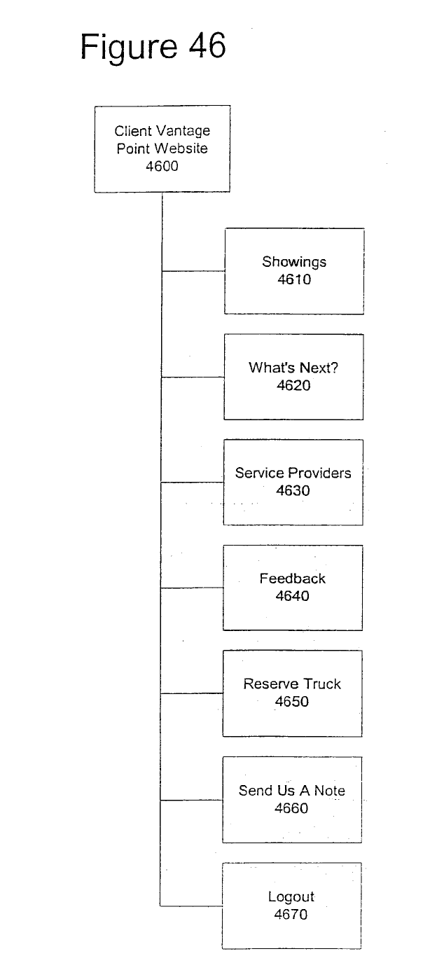

FIG. 46 shows a client vantage point website 4600. The client website may include information such as showings page 4610, what's next 4620, service providers 4630, feedback 4640, reserve truck 4650, send us a note 4660, and logout 4670.

Further, the showings module 240 may be configured to record any activity occurring at the product site. For example, if a selling Agent shows a product more than once, the listing Agent will know of the multiple visits, as well as any recorded information regarding the Agent, such as any previous visits to either a particular product or other properties visited in the past. The showings module 500 can also be used to provide feedback to a seller from a prospective buyer. For example, if a prospective buyer sees the seller's house and thinks the kitchen is outdated, the seller can then adjust the price taking this into account, or can remodel the kitchen. Additionally, a seller can use the showings module to compile a list of Agents who have shown a product and the seller can also broadcast messages to these Agents regarding price reduction or other updates, etc.

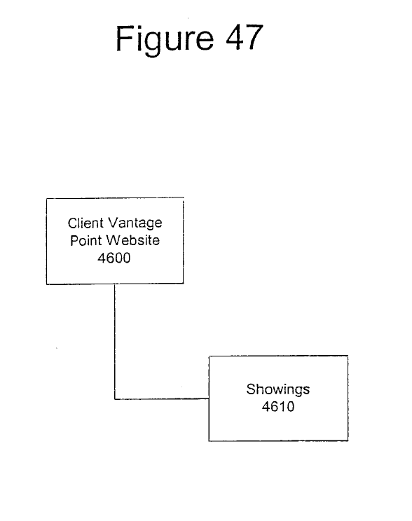

FIG. 47 shows additional detail regarding the showings option 4610. The showings option 4610 may be configured to record any activity occurring at the product site. For example, if a selling Agent shows a product more than once, the listing Agent will know of the multiple visits, as well as any recorded information regarding the Agent, such as any previous visits to either a particular product or other properties visited in the past. The showings module 500 can also be used to provide feedback to a seller from a prospective buyer. For example, if a prospective buyer sees the seller's house and thinks the kitchen is outdated, the seller can then adjust the price taking this into account, or can remodel the kitchen. Additionally, a seller can use the showings module to compile a list of Agents who have shown a product and the seller can also broadcast messages to these Agents regarding price reduction or other updates, etc.

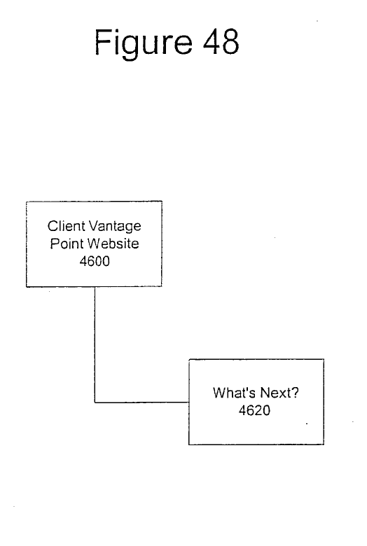

Additional detail regarding the what's next option 4620 is next provided. As shown in FIG. 48, the what's next page provides a client activity map which displays tasks that have been completed or need to be completed by the Agent. The activity map option may be displayed in calendar format, which can include a daily, weekly, or monthly format. Additionally, it can display responsible parties for each activity. Furthermore, the client activity map calendar format may be color coded based on the client's needs such as completed/due/ overdue/not due status.

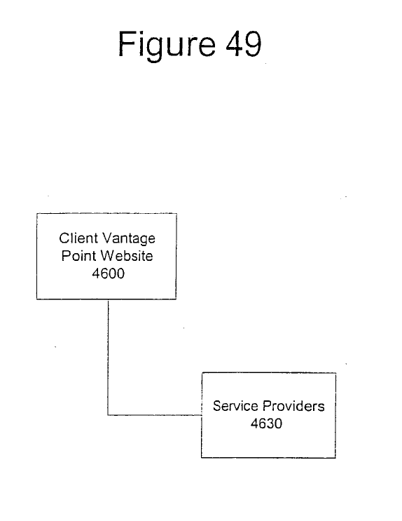

Additional detail regarding the service provider's option 4630 is next provided. Referring to FIG. 49, the service provider information database allows a user to supervise and keep updated on which service providers have completed their task and any comments made by third parties regarding the service provider. Furthermore, the service provider option may act as a referral database for the service providers wherein a client can look up a service provider and contact that service provider via the Internet or any other form of communication, for services.

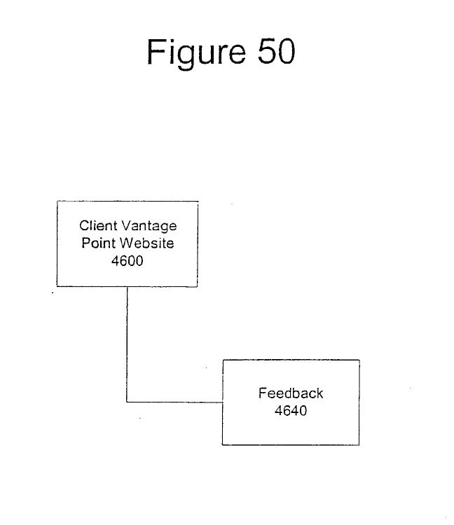

Additional information regarding the feedback option 4640 is next provided. As shown in FIG. 50, the feedback option can allow a client to rate the Agent or service provider via a ranking system. For example, a star system is used wherein the user may select the appropriate number of stars to signify the level of competence of the Agent or service provider. Preferably, the star system is based on a one to five scale. One being “okay”, five being “excellent.”

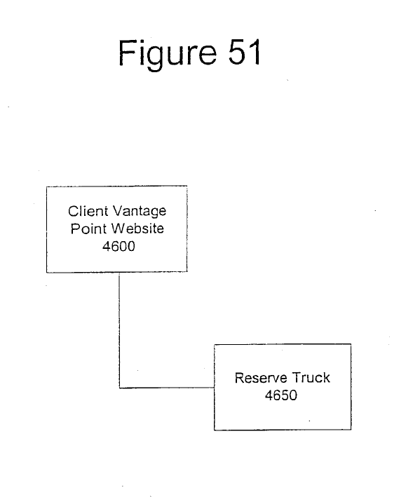

Additional information regarding reserve truck option 4650 is next provided. As shown in FIG. 51, a user may reserve a truck and view a calendar wherein availability status regarding truck reservations is available. For example, a solid block may be used to identify the times the truck is reserved.

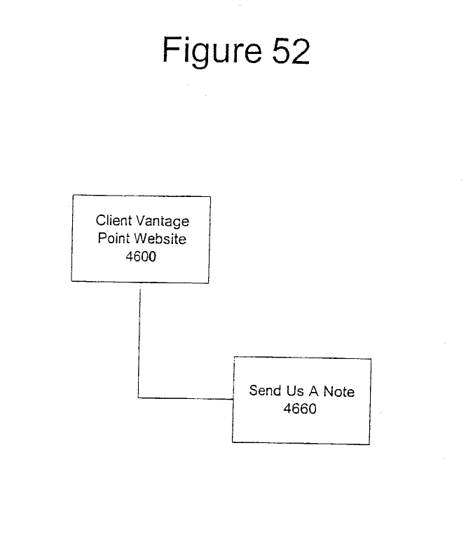

Additional information regarding send us a note option 4660 is next provided. As shown in FIG. 52, a user may fill out information via a feedback form, which allows a user to insert comments about an Agent, the webpage, or service provider in email format. The e-mail format allows a client or user to send an email directly to the Agent, administrator, or any interested party.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A web based information managing and transferring system accessible by end users, comprising:
an internet accessible host server, comprising:
a folder module adapted to contain information about a property or transaction;
a reports module communicatively coupled to the folder module, wherein the reports module is adapted to search and filter information from the folder module; and
a website management module communicatively coupled to at least one of the folder module or the reports module, wherein the website management module comprises at least one of a template based website development tool, a referral program tool, host system editing tool, a payment manager, a testimonial entry tool and a communication tool;
an internet connection between the host server and the internet; and
a display interface.

2. The system of claim 1, wherein the internet accessible host server is configured to carry at least one sequence of instructions for accessing transaction information stored in a database system, wherein execution of the at least one sequence of instructions by at least one processor comprises:
supplying to a user transaction information data elements that are attributes of at least one query by retrieving the information data elements directly from at least one database that contains the information data elements;
retrieving the one or more information data elements directly from at least one database; and
storing data information elements on the server.

3. The system of claim 2, wherein the supplying to the user of the transaction information data elements is performed by:
sending, from the server to the client over the network, data for only those attributes of the at least one query that is requested by the user;
retrieving the information data elements directly from the at least one database, placing the elements on a server computer;
transferring the information data elements from the server to a network; and
providing the information data elements to a user over a user interface, wherein the user is connected to the server computer over the network.

4. The system of claim 3, wherein the at least one database comprises a first, second, and third database, each of which is communicatively coupled to the other, and wherein each of the first, second, and third databases comprises at least one table.

5. The system of claim 4, wherein a single sign-on mechanism allows a user to log into the first, second, and third databases by using a single login.

6. The system of claim 1, further comprising an activity map module communicatively coupled to at least one of the folder module, the reports module or the website management module, wherein the activity map module comprises a data base of stored features and is adapted to extract information from at least one of the folder module and the reports module and manipulate the extracted information using the stored features to provide docketing information and calendaring functions to the end users.

7. The system of claim 6, wherein the stored features comprise at least one of a calculator to calculate due dates, a hyperlink to allow connecting between the folder module, the reports module and the activity map module, an automatic file saver, a new activity entry generator, a letter campaign generator, an instruction adding generator, and a note generator wherein the stored features comprise a calculator to calculate due dates, wherein the calculator receives information about the transaction from at least one of the folder module and reports module and manipulates the information to incorporate due dates for a transaction into a calendar.

8. The system of claim 6, wherein the stored features comprise at least one of a hyperlink to allow connecting between the folder module, wherein the hyperlink is presented on a display screen adapted for displaying predetermined information about a transaction and wherein when the hyperlink is activated, the display screen will switch the display from displaying one of the folder module, the reports module or the activity map module to displaying a different one of the folder module, the reports module, or the activity map module or an automatic file saver, wherein when a predetermined time elapses, all entries in the folder module, the reports module and/or the activity map module are automatically stored.

9. The system of claim 6, wherein the stored features comprise a new activity entry generator, wherein the new activity generator allows new activities to be entered into the management system and the folder module, the reports module and/or the activity map module.

10. The system of claim 6, wherein the stored features comprise a letter campaign generator, wherein the letter campaign generator compiles a list of prospective interested parties and generates letters, which include information from the folder module and/or reports module, to each of the prospective interested parties.

11. The system of claim 6, wherein the stored features comprise an instructions adding generator, wherein the instructions adding generator allows for end users to incorporate additional instructions in at least one of the folder module, the reports module or the activity map module for display to a display monitor.

12. The system of claim 6, wherein the stored features comprise a note generator, wherein the note generator allows for end users to incorporate notes into at least one of the folder module, the reports module or the activity map module for display to a display monitor.

13. The system of claim 6, further comprising a showings module communicatively coupled to at least one of the folder module, the reports module, and the activity map module, wherein the showings module is adapted to manage an information exchange between end users.

14. The system of claim 13, wherein the showings module tracks information entered by an Agent.

15. The system of claim 13, wherein the showings module compiles information from at least one of the folder module, the reports module, the activity map module and the showings module, determines specific interests of prospective parties and sends the compiled information to other users based upon the specific interests of prospective parties.

16. The system of claim 15, wherein the specific interests of prospective parties comprise property information and changes in property information.

17. The system of claim 16, wherein the property information comprises price, size, location, and sale status information and changes in prices and sale status information.

18. The system of claim 13, wherein the showings module further comprises at least one of a note recorder, an automatic feedback and comments receiver and display, and hyperlink to at least one of the folder module, the reports module, and the activity map module.

19. The system of claim 1, wherein the reports module comprises at least one of a transaction management report, an all due activities display, an all open activities display, a settlement summary display, an all showings display, a folder archive, a folder organizer and a folder detail compiler.

20. The system of claim 19, wherein the reports module comprises a transaction management report, wherein the transaction management report comprises a display indicating current and past due activities.

21. The system of claim 19, wherein the reports module comprises an all due activities display, where in the all due activities display comprises an appointment adding feature, wherein the appointment adding feature can add features not correlated to a transaction, and a display indicating current and past due activities.

22. The system of claim 1, wherein the folders module comprises an electronic repository for static information about a transaction.

23. The system of claim 22, wherein the static information comprises at least one of names and addresses of participants to a contract, types of participants to the transaction, hypertext links to at least one of the reports module and activity map module, offering price and descriptive physical information about property subject to the transaction.

24. The system of claim 23, wherein the descriptive physical information about the property subject to the transaction comprises at least one of number of bedrooms and bathrooms, room dimensions, map location, pictures or video images of the property subject to the transaction and acreage.

25. The system of claim 22, wherein the folders module is communicatively coupled to external sources which produce multimedia presentations of a property of the transaction, or list and publicize the property of the transaction.

26. The system of claim 1, further comprising a contact management module communicatively coupled to at least one of the folder module, the reports module or the activity map module.

27. The system of claim 26, wherein the contact management module comprises at a repository of contact information for other participants to a transaction.

28. The system of claim 27, wherein the other participants include agents, brokers, lenders, home inspection companies, attorneys and title companies.

29. The system of claim 1, further comprising a reservation module communicatively coupled to at least one of the folder module, the reports module or the activity map module, wherein the reservation module comprises a calendar to display equipment availability and editing tools to adjust the availability of the equipment.

30. The system of claim 1, further comprising a collective activity map module communicatively coupled to at least one of the folder module, the reports module or the activity map module, wherein the collective activity map module comprises a means for editing and packaging one or more predetermined activity maps, wherein each of the predetermined activity maps comprises a predetermined folder module, a predetermined reports module and a predetermined activity map module.

31. The system of claim 1, further comprising a transaction fee coordinating module communicatively coupled to at least one of the folder module, the reports module or the activity map module, wherein the transaction fee coordinating module comprises a usage tracking means, a usage time tracking means and a cost calculator, wherein the transaction fee coordinating module determines whether a user is transaction fee based and if so, calculates a transaction fee based upon the amount of usage and time of usage.

32. A computer-implemented web based method of generating information for management, comprising:
entering information regarding a transaction into a folder module;
compiling and filtering the information regarding the transaction using a reports module communicatively coupled to the folder module; and
automatically generating a calendar of activities and due dates from the information in the folder module and the reports module.

33. The method of claim 32, further comprising:
populating at least one table in at least one database with data information regarding a transaction;
assigning a unique identifier to the data information in the at least one table; and
providing data information corresponding to at least one user query by retrieving the data information elements directly from the at least one database that contains the data information.

34. The method of claim 33, wherein the at least one database comprises a first, second, and third database, each of which is communicatively coupled to the other databases, and wherein each of the first, second, and third databases comprises at least one table.

35. The method of claim 34, wherein a user logs into the first, second, and third databases by using a single login.

36. The method of claim 33, further comprising:
retrieving the data information directly from the at least one database, placing the data information on a server computer;
transferring the data information from the server to a network; and
providing the data information to a user over a user interface, wherein the user is connected to the server computer over the network.
